(19) United States
(12) Patent Application Publication
(10) Pub. No.: US 2016/0356438 A1
(43) Pub. Date: Dec. 8, 2016

(54) TACTICAL LIGHT APPARATUS

(71) Applicant: Gerald J. Matson, San Jose, CA (US)

(72) Inventor: Gerald J. Matson, San Jose, CA (US)

(21) Appl. No.: 14/731,282

(22) Filed: Jun. 4, 2015

(51) Int. Cl. F21L 4/02; F21L 4/08; F21V 23/04; H01Q 1/22

(52) U.S. Cl. CPC F21L 4/02; H01Q 1/22; F21L 4/08; F21V 23/0414; F21V 23/0435; F21V 23/0492; F21L 2001/00

(57) ABSTRACT

In one embodiment, an apparatus includes: a housing including at least two principle sides; an illumination structure protruding from each of the two principle sides, a stabilization pad protruding from each of the two principle sides; an electric circuit coupled to the housing; an antenna coupled to the housing; at least one orientation sensor coupled to the housing; and an electric power source coupled to the housing.

### FIELD OF THE INVENTION

The present invention relates to an apparatus for illumination, and more particularly, this invention relates to a tactical apparatus having a plurality of illumination structures on at least two surfaces thereof, where the tactical apparatus is particularly configured to be thrown and operated remotely.

### BACKGROUND

Portable, handheld lights are routinely used to illuminate darkened areas. For instance, law enforcement officers may use portable, handheld or weapon mounted lights, such as flashlights, to illuminate a darkened area for investigative purposes and/or to apprehend a potential adversary (e.g., a person suspected or accused of committing a crime)/ However, when such portable, handheld or weapon mounted lights are turned on, the location of the law enforcement officers holding said lights are revealed, which may expose the law enforcement officers to further danger.

Accordingly, law enforcement officers may turn to conventional tactical lights that are designed to be thrown into darkened areas for illumination purposes. Conventional tactical lights are typically turned on prior to being thrown into a darkened area, or have a delay timer configured to turn on the lights after a predetermined time delay. There are disadvantages associated with both configurations, however. For example, turning on the tactical lights prior to throwing them into a darkened area may also reveal the location of the law enforcement officers. Moreover, the predetermined time delay may be insufficient to allow the law enforcement officers to maintain the element of surprise or guarantee the anonymity of their location.

As such, there is a need in the art for a tactical apparatus that is configured to be thrown into a darkened area for illumination purposes, and operated remotely.

### SUMMARY

According to one embodiment, an apparatus includes: a housing including at least two principle sides; an illumination structure protruding from each of the two principle sides; a stabilization pad protruding from each of the two principle sides; an electric circuit coupled to the housing; an antenna coupled to the housing; at least one orientation sensor coupled to the housing; and an electric power source coupled to the housing.

Other aspects and advantages of the present invention will become apparent from the following detailed description, which, when taken in conjunction with the drawings, illustrate by way of example the principles of the invention

### BRIEF DESCRIPTION OF THE DRAWINGS

FIG. 1A is a top down view of a tactical light apparatus, according to one embodiment.

FIG. 1B is a cross sectional view of the tactical light apparatus of FIG. 1A.

FIG. 2A is a schematic representation of the tactical light apparatus of FIG. 1A in an intermediate stage of manufacture, according to one embodiment.

FIG. 2B is a schematic representation of a lid configured to cover a power source compartment described in FIG. 2A, according to one embodiment.

FIG. 3 is a schematic representation of the internal components of the tactical light apparatus of FIG. 1A, according to one embodiment.

FIG. 4 is a schematic representation of a protective cover, according to one embodiment.

FIG. 5 is a top down view of a tactical light apparatus having hexagonally shaped illumination structures, according to one embodiment.

FIG. 6 is a top down view of a tactical light apparatus having triangular shaped illumination structures, according to one embodiment.

FIG. 7 is a simplified representation of a tetrahedron shaped tactical light apparatus, according to one embodiment.

FIGS. 8A-8D are schematic representations of the communication between a remote activation device (e.g., a key fob) and a tactical light apparatus, according to various embodiments.

Reference should be made to the following detailed description, which when read in conjunction with the accompanying drawings, provides a fuller understanding of the nature and advantages of the present invention.

### DETAILED DESCRIPTION

The following description is made for the purpose of illustrating the general principles of the present invention and is not meant to limit the inventive concepts described herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

Further, as used herein, the term “about” when combined with a value refers to plus and minus 10% of the reference value. For example, a length of about 10 inches refers to a length of 10 inches±1 inch.

The following description discloses several preferred embodiments of a tactical, throwable apparatus for illumination and/or related systems and methods.

As discussed previously, conventional handheld or throwable lights suffer from safety concerns because they expose the location of the user. Embodiments disclosed herein are directed to overcome such safety concerns by providing a unique tactical, throwable apparatus, which may be particular useful for law enforcement, private security and other enforcement personnel that must enter darkened areas. For instance, the unique tactical apparatus disclosed herein may be configured to illuminate a 360 degree view so as to allow an area to be quickly scanned for evaluation purposes. Unlike handheld or weapon mounted lights (e.g., flashlights) that have a limited field of view, the unique tactical apparatus disclosed herein may be operated remotely to provide illumination without exposing the location of the enforcement personnel. In particular approaches, discrete LED light sources on the unique tactical apparatus may be activated, together or staggered, using Key Fob generated Radio Frequency. Accordingly, enforcement personnel no longer need to be in the visual field of the targeted subject. Additionally, the unique tactical apparatus disclosed herein may include at least one orientation sensor, such that when the apparatus is at rest, only the upward facing light sources may be turned “on” or “off” remotely.

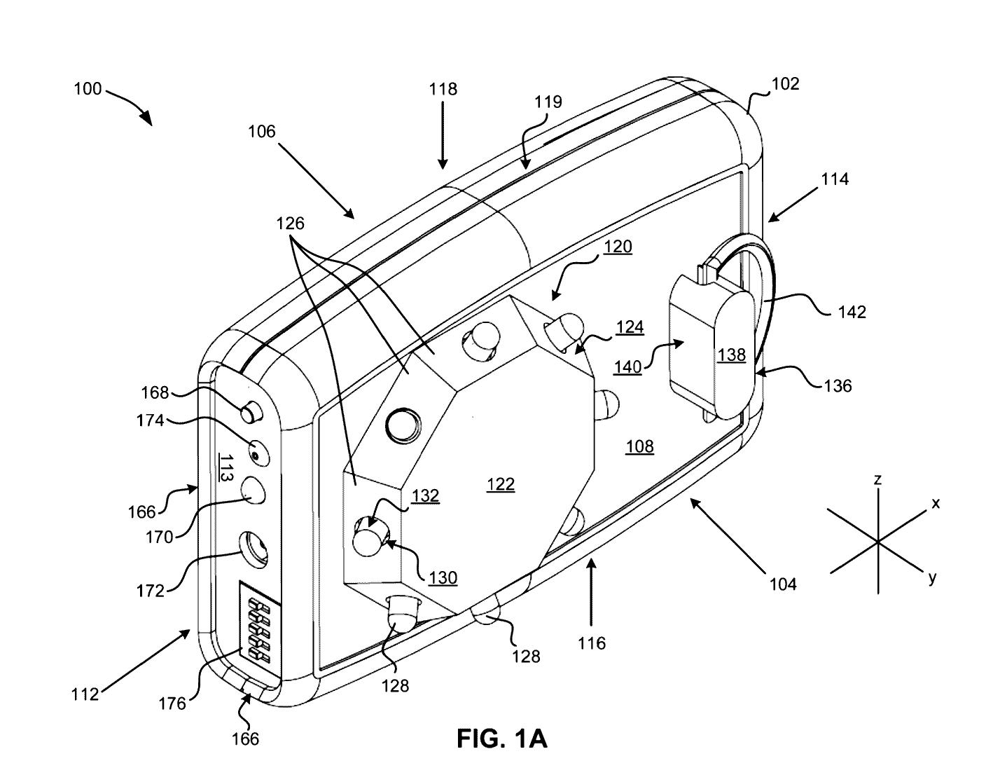

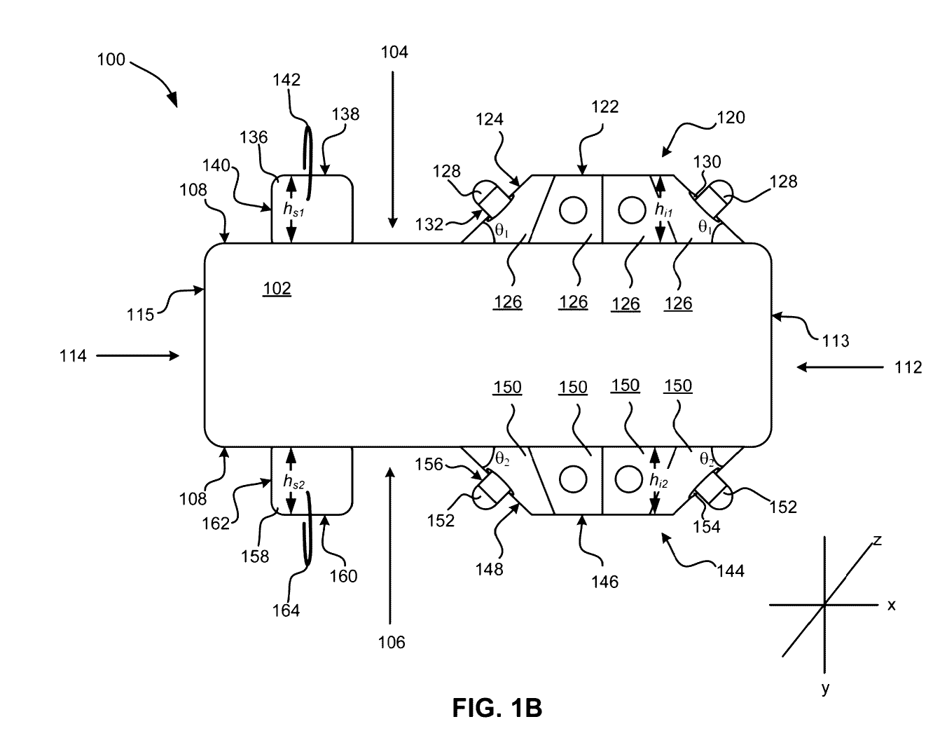

Referring now to FIGS. 1A-1B, various views of an apparatus 100 for illumination are shown according to one embodiment. The apparatus 100 may include and/or be used in conjunction with features from any other embodiment listed herein, such as those described with reference to the other FIGS. However, the apparatus 100, and others presented herein, may be used in various applications and/or in permutations which may or may not be specifically described in the illustrative embodiments listed herein. Moreover, unless otherwise specified, one or more components of the apparatus 100 may be of conventional material(s), design, fabricated using conventional techniques, and/or used in any desired environment as would become apparent to one skilled in the art upon reading the present disclosure.

As shown in the top down view and the cross-sectional view provided in FIGS. 1A and 1B, respectively, the apparatus includes a housing 102 having an exterior surface to which various external components may be coupled thereto and/or formed thereon. In the particular embodiment shown in FIG. 1A, the housing 102 may have a generally rectangular shape, with a first principle side 104, and a second principle side 106. As used herein in various approaches, a principle side may refer to a side comprising at least one illumination structure, such as those described in detail infra. In various approaches, the exterior surface 108 of the first principle side 104 may be flat, i.e., lie substantially in a same x-z plane as shown in FIGS. 1A-1B. Likewise, the exterior surface 110 of the second principle side 106 may be flat, i.e., lie substantially in a same x-z plane as shown in FIGS. 1A-1B. In preferred approaches, the exterior surface 108 of the first principle side 104 may lie along a plane that is oriented parallel to the plane along which the exterior surface 110 of the second principle side 106 lies.

As additionally shown in FIGS. 1A-1B, the housing 102 may also include a front side 112, a back side 114, and a pair of ancillary skies 116, 118, each of which connect the first principle side 104 to the second principle side 106. In preferred approaches, the front side, the back side, and/or the ancillary sides may have a predetermined curvature and/or be dimensioned so as to encourage the apparatus 100 to come to rest on one of its principle sides 104,106.

The generally rectangular shape of the housing 102 may be particularly suited to promote a desired orientation of the apparatus 100. For instance, in approaches where the apparatus 100 may be thrown a predetermined distance, the generally rectangular shape of the housing 102 may ensure that at least one of its principle sides 104,106 is not facing the ground, but rather is oriented generally upward so as to provide illumination to an area (e.g., a darkened room).

It is important to note however that the housing 102 is not limited to a generally rectangular shape. For example, in alternative approaches, the housing 102 may be any suitable shape having any number of principle sides provided said shape ensures that when the apparatus 100 is at rest, at least one principle side thereof will not face the ground but may be oriented generally upward so as to provide illumination to an area. Exemplary shapes for the housing 102 may include, but are not limited to, a square-based pyramid, a triangle-based pyramid, a triangular prism, a sphere, a cylinder, a cone, an ovoid, a cuboid, etc.

In yet more approaches, the housing 102 may have a particular mass distribution and/or a shape to ensure that when the apparatus 100 is at rest, at least one principle side thereof will not face the ground but may be oriented generally upward so as to provide illumination to an area. Such a mass distribution may be particularly useful in approaches where the housing 102 has a generally spherical, ovoid, cylindrical, etc. or otherwise rounded shape.

In additional approaches, the housing 102 may have an ergonomic shape configured to fit a human's hand.

As noted above, the housing 102 may be thrown by hand or by mechanical means into an area to-be-illuminated. Accordingly, in preferred approaches, the housing 102 may be configured to provide some level of shock/impact/drop resistance, dust resistance, water resistance, chemical resistance, and/or other forms of protection to protect the internal components thereof and to ensure reliability under various operating conditions.

In various approaches, the housing 102 may include at least one of a plastic material, and a metal material (such as aluminum, iron, etc.). It is important to note that in approaches where the housing 102 includes a metal material, an antenna configured to receive radio frequency signals (such as from a remote key fob) may need to be positioned on the exterior of the housing 102.

In particular approaches, the housing 102 may comprise a material that may be injection molded, including but not limited to, high-density polyethylene (HDPE), low density polyethylene (LDPE) polypropylene (PP), polycarbonate (PC), polystyrene (PS), polyethylene aphthalate (PEN), polyamide (PA), polyimide (PI), polyhydroxyalkalinic acid (PHA), styrene copolymers such as acrylonitrile-butadiene styrene (ABS), styrene acrylonitrile (SAN), polymethylmethacrylate (PMMA), polylactic acid (PLA), and/or combinations thereof.

In more approaches, the housing 102 may include a material that is water-resistant of waterproof. As used herein, a water resistant material may refer to a material that is capable of resisting or impeding the passage of liquid water by mass flow, capillary action, wicking action, etc. As also used herein, a waterproof material may refer to a material configured to withstand immersion in water or other non-corrosive or non-reactive liquid. In additional approaches, the design of the housing 102, e.g., the manner in which various components of the housing 102 may be connected together, may allow the housing 102 to be water resistant or waterproof.

In various approaches, the housing 102 may have a total weight in a range from about 0.25 lbs to about 2 lbs. Preferably, the housing 102 may have a total weight of about 0.5 lbs.

At least one of the principle sides 104,106 may have a length (extending along the x-axis in FIGS. 1A-1B) in a range from about 3 inches to about 10 inches, and/or a width (extending along the z axis in FIGS. 1A-1B) in a range from about 2 inches to about 10 inches, in some approaches. In a preferred approach, at least one of the principle sides 104,106 may have a length of about 4.61 inches, and a width of about 3.10 inches. In more preferred approaches, the length of the first principle side 104 may be about equal to the length of the second principle side 106. In yet more preferred approaches, the width of the first principle side 104 may be about equal to the width of the second principle side 106. However, in other approaches, the length of the first principle side 104 may be not be equal to the length of the second principle side 106; and/or the width of the first principle side 104 may not be about equal to the width of the second principle side 106.

As also shown in FIGS. 1A-1B, the apparatus includes a laterally opposed front side 112 and back side 114. In some approaches, at least one of the front and back sides 112,114 may have a length (extending along the z axis in FIGS. 1A-1B) in a range from about 2 inches to about 10 inches, and/or a width (extending along the y axis in FIGS. 1A-1B) in a range from about 0.3 inches to about 1.5 inches. In a preferred approach, at least one of the front and back sides 112,114 may have a length of about 3.10 inches, and a width of about 0.94 inches. In more preferred approaches, the length of the front side 112 may be about equal to the length of the back side 114. In yet more preferred approaches, the width of the front side 112 may be about equal to the width of the back side 114. In still more approaches, the length of each of the front and back sides 112,114 may be about equal to the width of each of the principle sides 104,106, as shown in the non-limiting embodiment of FIGS. 1A-1B.

In additional approaches, the front side 112 may include an exterior surface 113 that lies along a plane oriented substantially perpendicular to the exterior surfaces 108,110 of the first and second principle sides 104,106. Similarly, the back side 114 may include an exterior surface 115 (shown in FIG. 1B) that lies along a plane oriented substantially perpendicular to the exterior surfaces 108,110 of the first and second principle sides 104,106.

The apparatus 100 also includes a pair of laterally opposed ancillary sides 116,118. In some approaches, at least one of the ancillary sides 116,118 may have a length (extending along the x axis in FIGS. 1A-1B) in a range from about 3 inches to about 10 inches, and/or a width (extending along the y axis in FIGS. 1A-1B) in a range from about 0.3 inches to about 1.5 inches. In a preferred approach, at least one of the ancillary sides 116,118 may have a length of about 4.61 inches, and a width of about 0.94 inches. In more preferred approaches, the length of the ancillary side 116 may be about equal to the length of the ancillary side 118. In yet more preferred approaches, the width of the ancillary side 116 may be about equal to the width of the ancillary side 118. In still more approaches, the length of each of the ancillary sides 116,118 may be about equal to the length of each of the principle sides 104,106, as shown in the non-limiting embodiments of FIGS. 1A-1B.

In further approaches, the ancillary side 118 may include an exterior surface 119 that lies along to plane oriented substantially perpendicular to the exterior surfaces 108,110 of the first and second principle sides 104,106. Similarly, the ancillary side 116 may include an exterior surface (not shown in FIGS. 1A-1B) that lies along a plane oriented substantially perpendicular to the exterior surfaces 108,110 of the first and second principle sides 104,106.

The apparatus 100 additionally includes a first illumination structure 120 protruding from the exterior surface 108 of the first principle side 104. In some approaches, the distance that the first illumination structure 120 protrudes from the exterior surface 108 of the first principle side 104 (i.e., the height, hᵢ₁, of the first illumination structure 120) may be in a range from about 0 inches to about 1 inch. In a preferred approach, the height, hᵢ₁, of the first illumination structure 120 may be about 0.53 inches.

In various approaches, the first illumination structure 120 may be configured to provide some level of shock/impact/drop resistance, dust resistance, water resistance, chemical resistance, and/or other forms of protection to protect the internal components thereof and to ensure reliability under various operating conditions.

In particular approaches, the first illumination structure 120 may include at least one of a plastic material, and a metal material such as aluminum, iron, etc.). In particular approaches, the first illumination structure 120 may comprise one or more materials that may be injection molded, such as those disclosed herein.

In more approaches, the first illumination structure 120 may include a material that is water-resistant or waterproof. In additional approaches, the design of the first illumination structure 120, e.g., the manner in which various components of the first illumination structure 120 may be connected together, may allow the first illumination structure 120 to be water resistant or waterproof.

In yet more approaches, the first illumination structure 120 may include one or more of the same materials as the housing 102.

Preferably, the first illumination structure 120 may occupy less than or equal to about half the surface area of the first principle side 104. However, in alternative approaches, the first illumination structure 120 may occupy a majority of the surface area of the first principle side 104.

As shown in FIGS. 1A-1B, the first structure 120 has an exterior surface 122. In preferred approaches, the exterior surface 122 of the first illumination structure 120 may be along a plane that is substantially parallel to the exterior surface 108 of the first principle side 104.

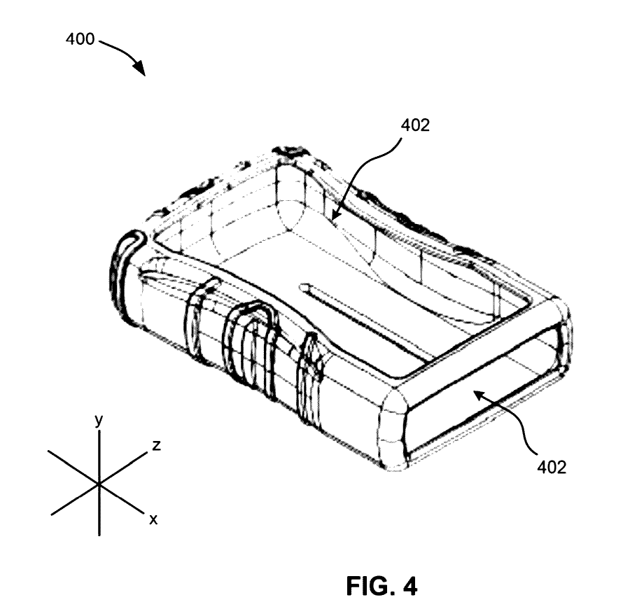

In one approach, an optional layer (not shown in FIGS. 1A-1B) may be positioned on a portion, a majority, or an entirety of the exterior surface 122 of the first illumination structure 120. This protective layer may be configured to mitigate and/or prevent damage to the first illumination structure 120 on impact. This protective layer may be removable or permanently affixed to the exterior surface 122 of the first illumination structure 120. In some approaches, this protective layer may comprise a impact resistant material, and/or a resilient, deformable material. In particular approaches, this protective laser may comprise rubber, plastic, silicone, or other suitable material configured to provide impact resistance. In one approach, this protective layer may include a layer of rubber cement affixed to an entirety of the exterior surface 122 of the first illumination structure 120. In another approach, this protective layer may include at least one layer of double back tape affixed to an entirety of the exterior surface 122 of the first illumination structure 120. In further approaches, this protective layer may be a separate component from, or a part of, the protective case 400 described in FIG. 4.

Again with reference to FIGS. 1A-1B, the first illumination structure 120 may have an octagonal cross sectional shape, where the cross section is taken perpendicular to the y-axis. However, it is important to note that the cross sectional shape of the first illumination structure 120 is not limited to an octagon. For example, other exemplary cross section shapes for the first illumination structure 120 may include a circle, an ellipse, an oval, a triangle, a square, a rectangle, a pentagon, a hexagon, a heptagon, a rhombus, etc.

The first illumination structure 120 may also have a side surface 124 that connects the exterior surface 122 of the first illumination structure 120 to the exterior surface 108 of the first principle side 104. In preferred approaches, the side surface 124 of the first illumination structure 120, regardless of the cross sectional shape thereof, may be faceted, i.e., comprises one or more facets. For example, in the embodiment shown in FIGS. 1A-1B, the side surface 124 of the first illumination structure 120 comprises 8 facets 126.

With particular reference to FIG. 1B, one or more of the facets 126 may be angled at an angle of inclination, θ₁, greater than 0° and less than or equal to about 90° relative to the exterior surface 108 of the first principle side 104. In one preferred approaches, θ₁ may be about 30 degrees. In more approaches, each of the facets 126 may be angled at the same angle of inclination relative to the exterior surface 108 of the first principle side 104. However, in other approaches, one some a majority, or all of the facets 126 of the first illumination structure 120 may each have a unique angle of inclination as compared to the other facets thereof, provided each unique angle of inclination falls within a range from greater than 0° to less than or equal to about 90° relative to the exterior surface 108 of the first principle side 104.

In one approach, at least one of the facets 126 may have at least one light source 128 coupled thereto. In another approach, at least one of the facets 126 may have a plurality of light sources 128 coupled thereto. In preferred approaches, each facet 126 may have at least one light source 128 coupled thereto, as particularly shown in the embodiment of FIG. 1A.

As also shown in the embodiment of FIGS. 1A-1B, each facet 126 may have an opening 130 through which a light source 128 may extend and protrude a predetermined amount. However, in other approaches, a portion, a majority or all of at least one light source 128 may be recessed relative to the facet 126 to which it is coupled provided that an effective amount of light from the light source 128 may still be transmitted through the opening 130.

In approaches where at least a portion of a light source 128 protrudes from an opening 130 in a facet 126, a small gap (e.g., less than about 0.01 of an inch) may be present between the side surface(s) 132 of the light source 128 and the opening 130 in the facet 126. In other approaches, there may be no gap between the side surface(s) 132 of the light source 128 and the opening 130 in the facet 126, which may aid in securing the light source 128 in place, reducing and/or eliminating dust from entering the internal compartment(s) of the first illumination structure 120, etc.

In yet more approaches, 1% to 100% of the surface area of at least one facet 126 may be occupied by a single light source 128 coupled thereto or by a plurality of light sources 128 coupled thereto.

In further approaches, an optional reflective coating may be present on the outward face of one or more of the facets 126. This optional reflective coating may include a thin film of aluminum, a thin film of silver, or other suitable reflective film configured to reflect the light from the light source 128 that falls on it.

It is important to note that the side surface 124 of the first illumination structure 120 need not be faceted. For example, in various approaches, the side surface 124 of the first illumination structure 120 may be a continuous surface to which at least one light source 128 is coupled.

While not shown in FIGS. 1A-1B, one or more light sources 128 may also be coupled to the exterior surface 122 of the first illumination structure 120 in some approaches.

The light sources 128 may include at least one of a light emitting diode (LED), an incandescent bulb, a reflectorized incandescent bulb, a tungsten-halogen bulb, a xenon bulb, a fluorescent bulb, a high-intensity discharge bulb (e.g., a metal halide bulb, high-pressure sodium bulb, low-pressure sodium bulb, mercury vapor bulb), a probe light, or other such suitable type of light source as would become apparent to one having skill in the art upon reading the present disclosure.

As discussed previously, the apparatus 100 may be thrown into a to-be-illuminated area thus, the apparatus 100 and the components thereon need to be of a suitable design and/or comprised of a suitable material to withstand such an impact. For instance, the height of the first illumination structure 120, the angle of inclination, θ₁, of each facet 126, the type of light source(s) 128, and/or the degree to which the light source(s) 128 protrude from the side surface 124 may be selected/configured so as to protect the light source(s) 128 when the apparatus 100 is thrown and comes to rest. In particular approaches, each of the light sources 128 may be a LED, as LEDs are durable due, in part, to their plastic, transparent casings. In approaches s here other types of light bulbs may be selected, such bulbs may need to have a similar impact/shock/drop resistant casing associated therewith.

In various approaches, at least one of the light sources 128 may operate in the visible spectrum, i.e., emit light with a wavelength in the range from about 390 nm to about 700 nm. For instance, at least one of the light, sources 128 may emit a spectral color (e.g., red, orange, yellow, green, blue, violet, etc.), or an unsaturated colors that are produced via a mixture of different wavelengths (e.g., magenta, pink, white, etc).

In various approaches, at least one of the light source 128 may have a brightness in a range from about 2 lumen to about 30 lumen.

In preferred approaches, each of the lights sources 128 of the first illumination structure 120 may be of the same type, emit light of the same wavelength, and/or have the same brightness. Alternatively, in other approaches, at least two, some, a majority, or all of the light sources 128 may be of a different type, emit light of a different wavelength, and/or have a different brightness from one another.

The light source(s) 128 may be in communication with an electric circuit encapsulated in an internal compartment of the housing 102. In particular approaches, a portion of the first principle side 104 located beneath the first illumination structure 120 may be removed so as to allow the first illumination structure 120 to be operatively coupled to said electric circuit.

While not shown in FIGS. 1A-1B, the apparatus 100 may include the first illumination structure 120 and at least one other illumination structure protruding from the exterior surface 108 of the first principle side 104. This additional illumination structure may, but need not, have the same cross-sectional shape, the same dimensions, the same number of facets (if any), and/or the same number and/or type of light sources 128 as the first illumination structure 120.

Again with reference to FIGS. 1A-1B, the apparatus 100 also includes a first stabilization pad 136 protruding from the exterior surface 108 of the first principle side 104. In some approaches, the distance that the first stabilization pad 136 protrudes from the exterior surface 108 of the first principle side 104 the height, hₛ₁, of the first stabilization pad 136) may be in a range from about 0 inches to about 1 inch. In a preferred approach, the height, hₛ₁, of the first stabilization pad 136 may be about 0.53 inches. In more approaches the height, sₛ₁, of the first stabilization pad 136 may be about equal to the height, hᵢ₁, of the first illumination structure 120.

In various approaches, the first stabilization pad 136 may have a design and/or a material that affords some level of shock/impact/drop resistance, dust resistance, water resistance, chemical resistance, etc.

In particular approaches, the first stabilization pad 136 may include at least one of a plastic material, and a metal material (such as aluminum, iron, etc.). In particular approaches, the first stabilization pad 136 may comprise one or more materials that may be injection molded, such as those disclosed herein.

In more approaches, the first stabilization pad 136 may include a material that is water-resistant or waterproof. In additional approaches, the design of the first stabilization pad 136, e.g., the manner in which various components of the first stabilization pad 136 may be connected together, may allow the first stabilization pad 136 to be water resistant or waterproof.

In yet more approaches, the first stabilization pad 136 may include one or more of the same materials as the housing 102 and/or the first illumination structure 120.

Preferably, the first stabilization pad 136 may occupy less than or equal to about half the surface area of the first principle side 104.

As shown in FIGS. 1A-1B, the first stabilization pad 136 has an exterior surface 138. In preferred approaches, the exterior surface 138 of the first stabilization pad 136 may lie along a plane that is substantially parallel to the exterior surface 108 of the first principle side 104. In yet more preferred approaches, the exterior surface 138 of the first stabilization pad 136 and the exterior surface 122 of the first illumination structure 120 may lie along substantially the same plane, a configuration that enables the apparatus 100 to lie flat on the floor when the first principle side 104 is facing the floor.

In one approach, an optional protective layer (not shown in FIGS. 1A-1B) may be positioned on a portion, a majority, or an entirety of the exterior surface 138 of the first stabilization pad 136. This protective layer may be configured to mitigate and/or prevent damage to the first stabilization pad 136 on impact. This protective layer may be removable or permanently affixed to the exterior surface 138 of the first stabilization pad 136. In some approaches, this protective layer may comprise a rigid, impact resistant material, and or a resilient, deformable material. In particular approaches, this protective layer may comprise rubber, plastic, silicone, or other suitable material configured to provide impact resistance. In one approach, this first protective layer may include a layer of rubber cement affixed to an entirety of the exterior surface 138 of the first stabilization pad 136. In another approach, this first protective layer may include a layer of double back tape affixed to an entirety of the exterior surface 138 of the first stabilization pad 136. In further approaches, this protective layer may be a separate component from, or a part of, the protective case 400 described in FIG. 4.

Again with reference to FIGS. 1A-1B, the first stabilization pad 136 may have a generally elliptical cross sectional shape, where the cross section is taken perpendicular to the y-axis. However, it is important to note that the cross sectional shape of the first stabilization pad 136 is not limited to an ellipse. For example, other exemplary cross section shapes for the first stabilization pad 136 may include a circle, an oval, a triangle, a square, a rectangle, a pentagon, as hexagon, a heptagon, an octagon, a rhombus, etc.

Additionally, the first stabilization pad 136 may have a side surface 140 that connects the exterior surface 138 of the first stabilization pad 136 to the exterior surface 108 of the first principle side 104. In preferred approaches, the side surface 140 of the first stabilization pad 136, regardless of the cross sectional shape thereof, may be continuous (i.e., not-faceted). However, in some approaches, the side surface 140 of the first stabilization pad 136 may include one or more facets. While not shown in FIGS. 1A-1B, in alternative approaches, the side surface 140 of the first stabilization pad 136 may also include one or more light sources 128), such as the light sources 128 coupled to the first illumination structure 120.

The first stabilization pad 136 may also optionally include a first fastening device 142. The first fastening device 142 may allow the apparatus 100 to be attached/mounted/physically coupled to an object or a person. For example, in the embodiment shown in FIGS. 1A-1B, the first fastening device 142 is a D ring, which may allow the apparatus to be mounted on a hook on a wall, to a piece of clothing on a person such as a belt or tactical jacket, to a strap on a bag, etc. The first fastening device 142 is not limited to a D ring, and may instead include, at least one of: a carbineer, a Velcro strap, a loop of webbing, a leather lace, a clip, a hook, or other such suitable fastening device as would become apparent one having skill in the art upon reading the present disclosure.

With particular reference to FIG. 1B, a second illumination structure 144 protrudes from the exterior surface 110 of the second principle side 106. In some approaches, the distance that the second illumination structure 144 protrudes from the exterior surface 110 of the second principle side 106 (i.e., the height, hᵢ₂, of the second illumination structure 144) may be in a range from about 0 inches to about 1 inch. In a preferred approach, the height, hᵢ₂, of the second illumination structure 144 may be about 0.53 inches. In more approaches, the height, hᵢ₂, of the second illumination structure 144 may be about equal to the height, hᵢ₁, of the first illumination structure 120.

In various approaches, the second illumination structure 144 may be configured to provide some level of shock/impact/drop resistance, dust resistance, water resistance, chemical resistance, and/or other forms of protection to protect the internal components thereof and to ensure reliability under various operating conditions.

In particular approaches, the second illumination structure 144 may include at least one of a plastic material, and a metal material (such as aluminum). In particular approaches, the second illumination structure 144 may comprise one or more materials that may be injection molded, such as those disclosed herein.

In more approaches, the second illumination structure 144 may include a material that is water-resistant or waterproof. In additional approaches, the design of the second illumination structure 144, e.g., the manner in which various components of the second illumination structure 144 may be connected together, may allow second illumination structure 144 to be water resistant or waterproof.

In yet more approaches, the second illumination structure 144 may include one or more of the same materials as the housing 102, the first illumination structure 120 and/or the first stabilization pad 136.

Preferably, the second illumination structure 144 may occupy less than or equal to about half the surface area of the second principle side 106. However, in alternative approaches, the second illumination structure 144 may occupy a majority of the surface area of the second principle side 106. In yet more approaches, the second illumination structure 144 may, but need not, have the same dimensions as the first illumination structure 120.

As shown in FIG. 1B, the second illumination structure 144 has an exterior surface 146. In preferred approaches, the exterior surface 146 of the second illumination structure 144 may lie along a plane that is substantially parallel to the exterior surface 110 of the second principle side 106.

In one approach, an optional protective layer (not shown in FIG. 1B) may be positioned on a portion, a majority, or an entirety of the exterior surface 146 of the second illumination structure 144. This protective layer may be configured to mitigate and/or prevent damage to the second illumination structure 144 on impact. This protective layer may be removable or permanently affixed to the exterior surface 146 of the second illumination structure 144. In some approaches, this protective layer may comprise a rigid, impact resistant material, and/or a resilient, deformable material. In particular approaches, this protective layer may comprise rubber, plastic, silicone, or other suitable material configured to provide impact resistance. In one approach, this protective layer may include a layer of rubber cement affixed to an entirety of the exterior surface 146 of the second illumination structure 144. In another approach, this protective layer may include a layer of double back tape affixed to an entirety of the exterior surface 146 of the second illumination structure 144. In further approaches, this protective layer may be a separate component from, or a part of, the protective case 400 described in FIG. 4.

Again with reference to FIG. 1B, in various approaches, the second illumination structure 144 may have an octagonal cross sectional shape, where the cross section is taken perpendicular to the y-axis. However, it is important to note that the cross sectional shape of the second illumination structure 144 is not limited to an octagon. For example, other exemplary cross section shapes for the second illumination structure 144 may include a circle, an ellipse, an oval, a triangle, a square, a rectangle, a pentagon, a hexagon, a heptagon, a rhombus, etc. In various approaches, the second illumination structure 144 may, but need not, have the same cross sectional shape as the first illumination structure 120.

Additionally, the second illumination structure 144 may have a side surface 148 that connects the exterior surface 146 of the second illumination structure 144 to the exterior surface 110 of the second principle side 106. In preferred approaches, the side surface 148 of the second illumination structure 144, regardless of the cross sectional shape thereof, may be faceted, i.e., comprises one or more facets. For example, in some approaches, the side surface 148 of the second illumination structure 144 comprises 8 facets 150. In approaches where both the first and second illumination structures 120,144 have faceted side surface, the first and second illumination structures 120,144 may, but need not, have the same number of facets.

Again with reference to FIG. 1B, one or more of the facets 150 may be angled at an angle of inclination, θ₂, greater than 0° and less than or equal to about 90° relative to the exterior surface 110 of the second principle side 106. In one preferred approaches, θ₂ may be about 30°. In more approaches, each of the facets 150 may be angled at the same angle of inclination relative to the exterior surface 110 of the second principle side 106. However, in other approaches, one, some, a majority, or all of the facets 150 of the second illumination structure 144 may each have a unique angle of inclination as compared to the other facets thereof, provided each unique angle of inclination falls within a range from greater than 0° to less than or equal to about 90° relative to the exterior surface 110 of the second principle side 106.

In one approach, at least one of the facets 150 may have at least one light source 152 coupled thereto. In another approach, at least one of the facets 150 may have a plurality of light sources 152 coupled thereto. In preferred approaches, each facet 150 may have at least one light source 152 coupled thereto.

Each facet 150 may have an opening 154 through which a light source 152 may extend and protrude a predetermined amount. However, in other approaches, a portion, a majority or all of at least one light source 152 may be recessed relative to the facet 150 to which it is coupled provided that an effective amount of light from the light source 152 may still be transmitted through the opening 154.

In approaches were at least a portion of a light source 152 protrudes from an opening 154 in a facet 150, a small gap (e.g., less than about 0.01 of an inch) may be present between the side surface(s) 156 of the light source 152 and the opening 154 in the facet 150. In other approaches, there may be no gap between the side surface(s) 156 of the light source 152 and the opening 154 in the facet 150, which may aid in securing the light source 152 in place, reducing and/or eliminating dust from entering the internal compartment(s) of the second illumination structure 144, etc.

In yet more approaches, 1% to 100% of the surface area of at least one facet 150 may be occupied by a single light source 152 coupled thereto or by a plurality of light sources 152 coupled thereto.

In further approaches, an optional reflective coating may be present on the outward face of one or more of the facets 150. This optional reflective coating may include a thin film of aluminum, a thin film of silver, or other suitable reflective film configured to reflect the light from the light source 152 that falls on it.

It is important to note, that the side surface 148 of the second illumination structure 144 need not be faceted. For example, in various approaches, the side surface 148 of the second illumination structure 144 may be a continuous surface to which at least one light source 152 is coupled.

While not shown in FIG. 1B, one or more light sources 152 may also be coupled to the exterior surface 146 of the second illumination structure 144 in some approaches.

In various approaches, the light source 152 may include at least one of: a light emitting diode (LED), an incandescent bulb, a reflectorized incandescent bulb, a tungsten-halogen bulb, a xenon bulb, a fluorescent bulb, a high-intensity discharge bulb (e.g., a metal halide bulb, high-pressure sodium bulb, low-pressure sodium bulb, mercury vapor bulb), a probe light, or other such suitable type of light source as would become apparent to one having skill in the art upon reading the present disclosure.

As discussed previously, the apparatus 100 may be thrown into a to-be-illuminated area; thus, the apparatus 100 and the components thereon need to be of a suitable design and/or comprised of a suitable material to withstand such an impact. For instance, the height of the second illumination structure 144, the angle of inclination, θ₂, of each facet 150, the type of light source(s) 152, and/or the degree to which the light source(s) 152 protrude from the side surface 148 may be selected/configured so as to protect the light source(s) 152 when the apparatus 100 is thrown and comes to rest. In particular approaches, each of the light sources 152 may be a LED, as LEDs are durable due, in part, to their plastic, transparent casings. In approaches where other types of light bulbs may be selected, such bulbs may need to have a similar impact/shock/drop resistant casing associated therewith.

In various approaches, at least one of the light sources 152 may operate in the visible spectrum, i.e., emits light with a wavelength in the range from about 390 nm to about 700 nm. For instance, at least one of the light sources 152 may emit a spectral color (e.g., red, orange, yellow, green, blue, violet, etc.), or an unsaturated colors that are produced via a mixture of different wavelengths (e.g., magenta, pink, white, etc.).

In some approaches, at least one of the light sources 152 may have a brightness in a range from about 2 lumen to about 30 lumen.

In preferred approaches, each of the lights sources 152 of the second illumination structure 144 may be of the same type, emit light of the same wavelength, and/or have the same brightness. Alternatively, in other approaches, at least two, some, a majority, or all of the light sources 152 may be of a different type, emit light of a different wavelength, and/or have a different brightness from one another.

In various approaches, one or more of the light sources 152 coupled to the second illumination structure 144 may, but need not, be the same type, emit light of the same type, and/or have the same brightness as one or more of the light sources 128 coupled to the first illumination structure 120.

The light sources 152 of the second illumination structure 144 may be in communication with an electric circuit encapsulated in an internal compartment of the housing 102. In particular approaches, to portion of the second principle side 106 located beneath the second illumination structure 144 may be removed so as to allow the second illumination structure 144 to be operatively coupled to said electric circuit.

While not shown in FIG. 1B, the apparatus 100 may include the second illumination structure 144 and at least one other illumination structure protruding from the exterior surface 110 of the second principle side 106. This additional illumination structure may, but need not, have the same cross-sectional shape, the same dimensions, the same number of facets (if any), and/or the same number and/or type of light sources 152 as the second illumination structure 144.

Again with reference to FIG. 1B, the apparatus 100 also includes a second stabilization pad 158 protruding from the exterior surface 110 of the second principle side 106. In some approaches, the distance that the second stabilization pad 158 protrudes from the exterior surface 110 of the second principle side 106 (i.e., the height, hₛ₂, of the second stabilization pad 158) may be in a range from about 0 inches to about 1 inch. In a preferred approach, the height, hₛ₂, of the second stabilization pad 158 may be about 0.53 inches. In more approaches, the height, hₛ₂, of the second stabilization pad 158 may be about equal to the height, hᵢ₂, of the second illumination structure 144. In yet more approaches, the height, hₛ₂, of the second stabilization pad 158 may be about equal to the height, hₛ₁, of the first stabilization pad 136.

In various approaches, the second stabilization pad 158 may have a design and/or a material that affords some level of shock/impact/drop resistance, dust resistance, water resistance, chemical resistance, etc

In particular approaches, the second stabilization pad 158 may include at least one of a plastic material, and a metal material (such as aluminum, iron, etc.). In particular approaches, the second stabilization pad 158 may comprise one or more materials that may be injection molded, such as those disclosed herein.

In more approaches, the second stabilization pad 158 may include a material that is water-resistant or waterproof. In additional approaches, the design of the second stabilization pad 158, e.g., the manner in which various components of the second stabilization pad 158 may be connected together, may allow the second stabilization pad 158 to be water resistant or waterproof.

In yet more approaches, the second stabilization pad 158 may include one or more of the same materials as the housing 103, the second illumination structure 144, the first illumination structure 120, and/or the first stabilization pad 136.

Preferably, the second stabilization pad 158 may occupy less than or equal to about half the surface area of the second principle side 106. In yet more approaches, the second stabilization pad 158 may, but need not, have the same dimensions as the first stabilization pad 136.

As shown in FIG. 1B, the second stabilization pad 158 has an exterior surface 160. In preferred approaches, the exterior surface 160 of the second stabilization pad 158 may lie along a plane that is substantially parallel to the exterior surface 110 of the second principle side 106. In yet more preferred approaches, the exterior surface 160 of the second stabilization pad 158 and the exterior surface 146 of the second illumination structure 144 may lie along substantially the same plane, a configuration that enables the apparatus 100 to lie flat on the floor when the second principle side 196 is facing the floor.

In one approach, an optional protective layer (not shown in FIG. 1B) may be positioned on a portion, a majority, or an entirety of the exterior surface 160 of the second stabilization pad 158. This protective layer may be configured to mitigate and/or prevent damage to the second stabilization pad 158 on impact. This protective layer may be removable or permanently affixed to the exterior surface 160 of the second stabilization pad 158. In some approaches, this protective, layer may comprise a rigid, impact resistant material, and/or a resilient, deformable material. In particular approaches, this protective layer may comprise rubber, plastic, silicone, or other suitable material configured to provide impact resistance. In one approach, this first protective layer may include a layer of rubber cement affixed to an entirety of the exterior surface 160 of the second stabilization pad 158. In another approach, this first protective layer may include, a layer of double back tape affixed to an entirety of the exterior surface 160 of the second stabilization pad 158 in one approach, this first protective layer may include a layer of rubber cement affixed to an entirety of the exterior surface 160 of the second stabilization pad 158. In further approaches, this protective layer may be a separate component from, or a part of, the protective case 400 described in FIG. 4.

Again with reference to FIG. 1B, in various approaches, the second stabilization pad 158 may have a generally elliptical cross sectional shape, where the cross section is taken perpendicular to the y-axis. However, it is important to note that the cross sectional shape of the second stabilization pad 158 is not limited to an ellipse. For example, other exemplary cross section shapes for the second stabilization pad 158 may include a circle, an oval, a triangle, a square, a rectangle, a pentagon, a hexagon, a heptagon, an octagon, a rhombus, etc. In various approaches, the second stabilization pad 158 may, but need not, have the same cross sectional shape as the first stabilization pad 136.

The second stabilization pad 158 may also have a side surface 162 that connects the exterior surface 160 of the second stabilization pad 158 to the exterior surface 110 of the second principle side 106. In preferred approaches, the side surface 162 of the second stabilization pad 158, regardless of the cross sectional shape thereof, may be continuous (i.e., not-faceted). However, in some approaches, the side surface 162 of the second stabilization pad 158 may include one or more facets. While not shown in FIG. 1B, in alternative approaches, the side surface 162 of the second stabilization pad 158 may also include one or more light sources 152 in additional approaches, such as the light sources 152 coupled to the second illumination structure 144.

Still with reference to FIG. 1B, the second stabilization pad 158 may optionally include a second fastening device 164. The second fastening device 164 may allow the apparatus to be attached/mounted/physically coupled to an object or a person. For example, in the embodiment shown in FIG. 1B, the second fastening device 164 is a D ring, which may allow the apparatus to be mounted on a hook on a wall, to a piece of clothing on a person such as a belt or tactical jacket, to a strap on a bag, etc. The second fastening device 164 is not limited to a D ring, and may instead include at least one of a carbineer, a Velcro strap, a loop of webbing, a leather lace, a clip, a hook, or other such suitable fastening device, as would become apparent one having skill in the art upon reading the present disclosure. In various approaches, the second fastening device 164 may, but need not, be the same as the first fastening device 142.

It is important to note that while not particularly shown in FIGS. 1A-1B, one or more additional components may be positioned on the exterior surface of one or both of the principle sides 104,106. These additional components may be positioned, on at least one of the principle sides of the apparatus 100 and/or be constructed with particular dimensions so as to not interfere with/block the light output from the illumination structures and/or prevent the apparatus 100 from achieving, a desired post-landing orientation i.e., with one of its principle sides 104,106 facing upward relative to a floor surface) after being thrown. Moreover, these additional components may be of conventional material(s), design, and/or fabricated using conventional techniques as known in the art.

An exemplary additional component may include an audio device configured to emit a predetermined audible sound, where the audible sound may include a voice message, a single beeping sound, a succession of beeping sounds, etc. to warn and/or disorient potential adversaries. In some approaches, the audio device may be turned on by a switch or button on the apparatus 100 (not shown). When the audio device is turned on, the audio device may emit the audible sound immediately or after a predetermined delay period. In more approaches, the audio device may be operated remotely.

Another exemplary additional component may include a camera configured to take video images and/or still images at a predetermined frequency. In some approaches, the camera may be coupled to a rotatable mount, which may be driven by a motor, to allow the camera to rotate 360° horizontally and 180° vertically. In more approaches, the camera may be turned on by a switch or button on the apparatus 100 (not shown). When the camera is turned on, the camera may begin to take video and/or still images immediately or after a predetermined delay period. in other approaches, the camera may be operated remotely.

Yet another exemplary additional component may include a device for dispensing a chemical, such as tear gas, that is configured to disorient a potential adversary. In various approaches, the dispensing device may also be turned on by a switch or button on the apparatus 100 (not shown). When the dispensing device is turned on, the dispensing device may begin to release its contents immediately or after a predetermined delay period. In other approaches, the dispensing device may be operated remotely.

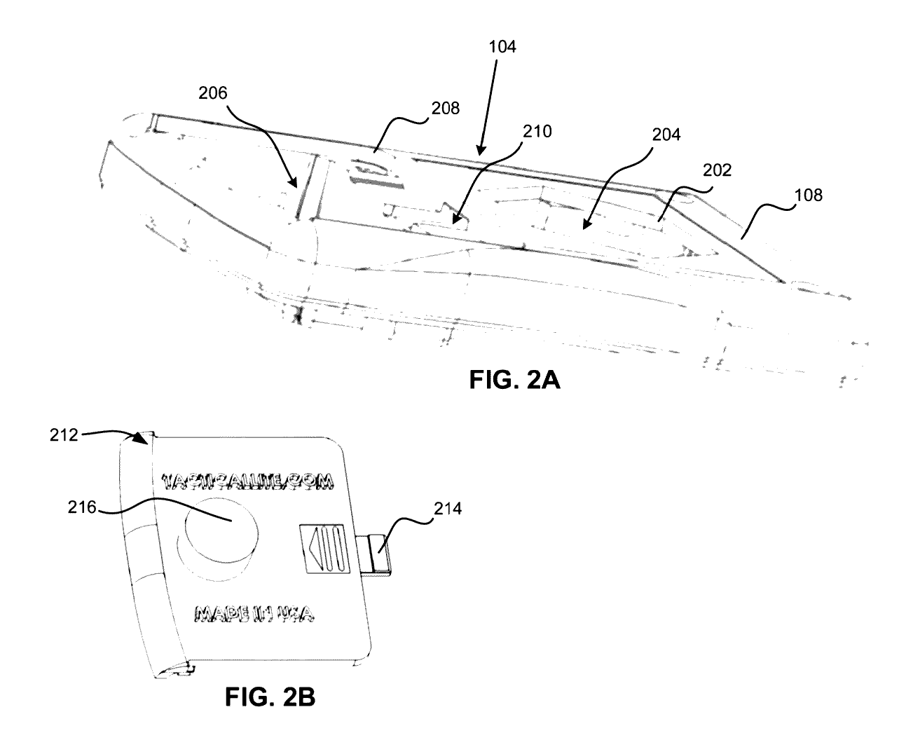

As noted previously with reference to FIGS. 1A-1B, the light sources 128, 152 of the first and second illumination structures 120, 144 may each be in communication with an electric circuit encapsulated in an internal compartment of the housing 102. FIG. 2A provides a simplified schematic of the apparatus 100 (of FIGS. 1A-1B) in an intermediate stage of manufacture, which illustrates a configuration that allows the light sources 128, 152 to be operatively coupled to said electric circuit. For instance, as shown in FIG. 2A, a first opening 202 is located in the exterior surface 108 of the first principle side 104 to allow access to a first internal compartment 204 of the housing 102. The to-be-attached first illumination structure 129 (not shown) is preferably positioned above this first opening 202, thus allowing as pathway by which the light source(s) 128 of the first illumination structure 120 may be operatively coupled to an electric circuit present in the first internal compartment 204.

While not shown in the view provided in FIG. 2A, there may be a second opening in the exterior surface 110 of the second principle side 106 to allow access to the first internal compartment 204 of the housing 102. The to-be-attached second illumination structure 144 (not shown) is preferably positioned above this second opening, thus allowing a pathway by which the light source(s) 152 of the second illumination structure 144 may be operatively coupled to an electric circuit present in the first internal compartment 204.

As shown in FIG. 2A, there may also be a second internal compartment 206 of the housing 102 that preferably encapsulates the power source (not shown) of the apparatus 100. In some approaches, the power source of the apparatus 100 may include any known primary cell (non-rechargeable battery) such as an alkaline battery, a lithium battery, etc. In other approaches, the power source of the apparatus 100 may include any known secondary cell (rechargeable battery) such as lithium-ion, NiCD, RAM, NiMh, etc. batteries.

In approaches were the power source is a non-rechargeable battery, there may be a third opening 208 in the exterior surface of one of the principle sides of the apparatus 100 to allow access to the second internal compartment 206. In the particular non-limiting embodiment of FIG. 2A, this third opening 208 is located in the exterior surface 108 of the first principle side 104. The to-be-attached first stabilization pad 136 (not shown) may be positioned above this third opening 208.

A to-be-attached lid (not shown) may be secured to the apparatus 100 at a lid attachment position 210 and completely cover the third opening 208. This lid may preferably be made of one or more of the same materials as the housing 102. FIG. 2B illustrates one such exemplary lid 212, which may include an attachment segment 214 that is configured to secure to the lid attachment position 210 (shown in FIG. 2A). Moreover, as also shown in FIG. 28, the first stabilization pad 136 may protrude from the exterior surface 216 of the lid 212.

It is important to note, that in approaches where the power source is a rechargeable battery, there may be no opening (e.g., no third opening 208) in either of the principle sides that allows access to the second internal compartment 206.

Again with reference to FIG. 1A, the front side 112 of the apparatus 100 includes an exterior surface 113 that may be recessed relative to the peripheral edges 166 of the front side 112. The exterior surface 113 may be preferably recessed so as to protect one or more components located thereon. In some approaches, the exterior surface 113 may be preferably recessed about 0.10 to about 0.20 inches relative to the front sides' peripheral edges 166. While not shown in FIG. 1A, an optional hinged cover may be coupled to the peripheral edges 166 to offer additional protection to the components present on the recessed exterior surface 113. This optional hinged cover may comprise one or more of the same materials as the housing 102, and may be transparent or opaque. While also not shown in the particular embodiment of FIG. 1A, the exterior surface 113 may not be recessed, but may be flush with (i.e., lie in the same plane as) the front sides' peripheral edges 166.

As shown in FIG. 1A, an optional status indicator light source 174 may be flush with or protrude from the exterior surface 113 of the front side 112. In preferred approaches, the status indicator light source 174 may be configured to provide an optical indication with regard to operational mode and/or battery charge state. For instance, in some approaches, the status indicator light source 174 may emit visible light of a predetermined wavelength and/or brightness in at least one of the following circumstances: when one of the selector switches (described in detail below) is set to the on position; when the light source(s) 128 on the first illumination structure 120 emit light; when the light source(s) 152 on the second illumination structure 144 emit light; when the power source of the apparatus 100 needs charging; when the power source of the apparatus 100 is being charged, etc. In approaches, where the status indicator light source 174 may emit visible light in more than one of the aforementioned circumstances, the status indicator light source may emit light of a different wavelength and/or brightness for each specific circumstance. The status indicator light source 174 may preferably be a LED, but may also be an incandescent bulb, a reflectorized incandescent bulb, a tungsten-halogen bulb, a xenon bulb, a fluorescent bulb, a high-intensity discharge bulb (e.g., a metal halide bulb, high-pressure sodium bulb, low-pressure sodium bulb, mercury vapor bulb), or other such suitable type of light source as would become apparent to one having skill in the art upon reading the present disclosure. In various approaches, the status indicator light source 174 may be about the same size or smaller than the light source(s) 128 coupled to the first illumination structure 120 and/or the light source(s) 152 coupled to the second illumination structure 144.

As additionally shown in FIG. 1A, an optional reading light source 170 may be flush with or protrude from the exterior surface 113 of the front side 112. This reading light source 170 may be preferably configured to output visible light of a predetermined wavelength and/or brightness so as to illuminate, objects in front of the reading light source 170. For example, the reading light source 170 may be used similar to a flashlight. The reading light source 1.70 may preferably be a LED, but may also be an incandescent bulb, a reflectorized incandescent bulb, a tungsten-halogen bulb, a xenon bulb, a fluorescent bulb, a high-intensity discharge bulb (e.g., a metal halide bulb, high-pressure sodium bulb, low-pressure sodium bulb, mercury vapor bulb), or other such suitable type of light source as would become apparent to one having skill in the art upon reading the present disclosure. In one particular approach, the reading light source 170 may be a high intensity white LED configured to provide a light output that is sufficient to allow reading with but is less than a conventional flashlight. In various approaches, the reading light source 170 may be about the same size or larger than any of the following: the status indicator light source 174, the light source(s) 128 coupled to the first illumination structure 120, and the light source(s) 152 coupled to the second illumination structure 144.

As further shown in FIG. 1A, the exterior surface 113 may have a charging connector 172 configured to connect the power source of the apparatus 100 to a charging apparatus not shown) via a charging cable. In one approach, the charging apparatus may include a 9 volt AC/DC wall adapter unit. In another approach, the charging apparatus may include a cigarette plug connected to a 2.2/5/5 mm cable. In yet another approach, the charging apparatus may include a 9 volt battery and have at least one of: a 2.2/5.5 mm output with always on, steady voltage-one; a flashing voltage with an on/off switch; an always on cigarette socket; and a battery charged always on 2.2/5.5 mm socket. In a further approach, the charging apparatus may include a 9 volt lithium ion AC all charging unit.

A power button 168 may also be flush with or protrude from the exterior surface 113 of the front side 112. In preferred approaches, this power button 168 may be depressed/pushed to both power on and power off the apparatus 100. For instance, a first push of the power button 168 may turn on the apparatus 100, whereas a subsequent push of the power button 168 may power off the apparatus 100. In preferred approaches, when the power button 168 is pushed to power on the apparatus 100, the apparatus 100 may immediately turn on. In additional approaches, the power button 168 may be pushed for a minimum of 2 seconds to power off the apparatus 100. This power off delay prevents the apparatus 100 from accidently turning off if the power button 168 is humped at impact (e.g., after the apparatus 100 has been thrown). The power button 168 need not be a button that requires depression/pushing to power on/off, but may rather be a switch that requires sliding a lever to power on/off in alternative approaches.

As shown in FIG. 1A, the exterior surface 113 of the front side 112 comprises a dual in line package (DIP) switch 176 that comprises least five switches. In some approaches, at least one of the five selector switches may be associated with the reading light source 170 such that when said switch is activated (set to an “on” position), the reading light source 170 may immediately emit visible light. In other approaches, when the switch associated with the reading light source 170 switch is activated (set to “on”), the apparatus 100 (particularly the internal circuitry included therein) may be configured to receive a signal (e.g., a radio frequency signal) from a remote activation device that instructs the reading light source 170 to emit visible light. Accordingly, upon receipt of this “reading light instruction” signal, the reading light will emit visible light. For instance, the reading light source 170 may be controlled by a unique activation button of a remote activation device (e.g., a key fob), such that when the switch associated with the reading light source 170 is activated (set to “on”) and the corresponding activation button is pushed/depressed, the reading light source 170 emits visible light.

Additionally, at least one of the selector switches may be associated with the illuminations structures, particularly the light source(s) coupled thereto. In various approaches, when the switch associated with the illuminations structures is activated (set to “on”), the apparatus 100 (particularly the internal circuitry included therein) may be configured to receive a signal (e.g., a radio frequency signal) from a remote activation device that instructs the light source(s) coupled to the illumination structures to emit visible light. Accordingly, upon receipt of this “illumination structure instruction” signal, the light(s) coupled to the illumination structures will emit visible light. For instance, the illumination structures may be controlled by a unique activation button of a remote activation device (e.g., a key fob), such that when the switch associated with the illumination structures is activated (set to “on”) and the corresponding activation button is pushed/depressed, the light source(s) coupled to the illuminations structures emit visible light. It is important to note that in preferred approaches, only the light source(s) of the illuminating structure that is(are) facing upward and away from a floor source may emit visible light, a result facilitated by an orientation sensor located within an internal compartment of the apparatus and operatively coupled to the illumination structures.

In preferred approaches, at least four of the selector switches may be associated with the illuminations structures, particularly the light source(s) coupled thereto. For example, each of these four switches may correspond to a unique activation button on a remote activation device (e.g., a key fob), such that when one of these four switches is activated (set to “on”) and the corresponding active button is pushed/depressed, the light source(s) coupled to the illuminations structures emit visible light.

In yet more preferred approaches, only one of the selector switches may be activated (e.g., set to “on”) at a time. It is important to note that the apparatus 100 need not have five selector switches as shown in FIG. 1A. For instance, the total number of selector switches may be one, two, three, four, five, six, etc. in alternative approaches. Moreover, these selector switches may be rocker switch, a rotary switch, a slide switch, etc.

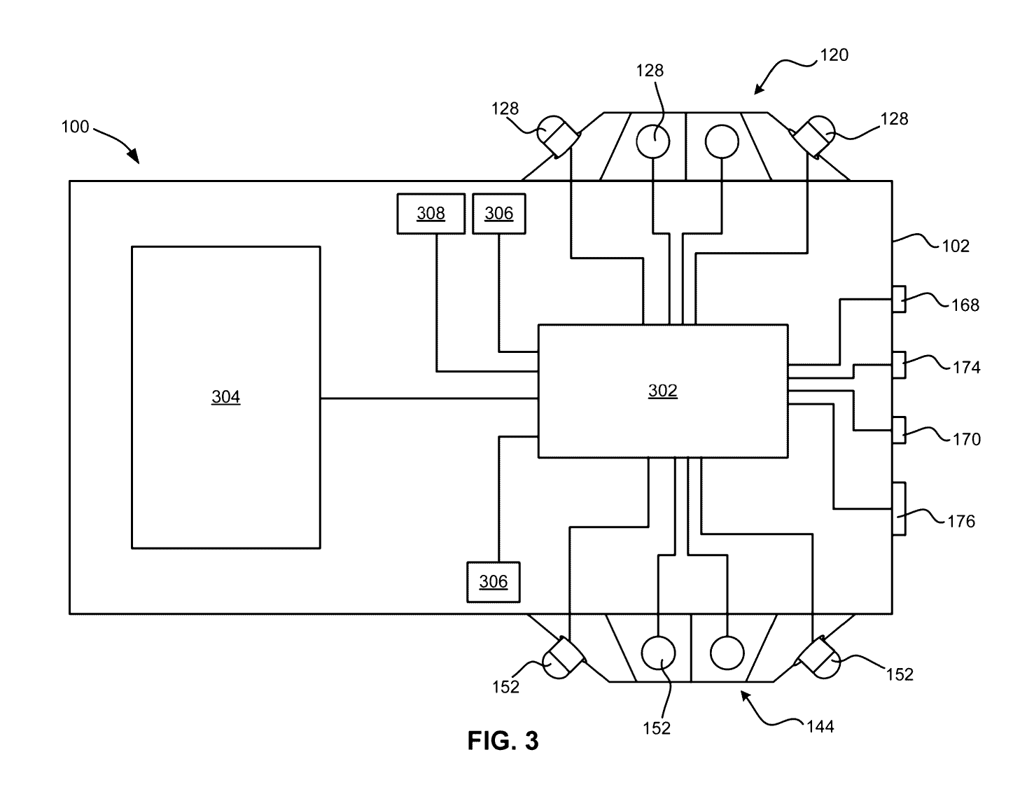

Referring now to FIG. 3, a simplified, schematic of various internal components contained within the housing 102 of the tactical light apparatus 190 (of FIGS. 1A-1B) are shown, according to one embodiment. As discussed previously and as shown in FIG. 3, the interior of the housing 102 may have a first internal compartment that includes at least one electric circuit 302, and second internal compartment that includes a power source 304.

In various approaches, the electric circuit 302 may be a combination of interconnected circuit elements associated on or within a continuous substrate, where the substrate may include, but is not limited to, a semiconductive substrate, a printed circuit board (PCB), an adhesive backing, etc. In particular approaches, the electric circuit 302 may be a monolithic integrated circuit wherein all circuit components are manufactured into or on top of a single chip of silicon or layer of semiconductive material.

The power source 304 may be configured to supply power to the electric circuit 302, as well as the light sources 128,152 of the first and second illumination structures 120,144 and any other additional light sources coupled to the apparatus 109. In one approach, the power source 304 may be a single primary cell (non-rechargeable battery) or a plurality of primary cells. In another approach, the power source 304 may be a single secondary cell (rechargeable battery) or a plurality of secondary cells.

The light sources 128,152 of the first and second illumination structures 120,144 may be in electrical communication with the electric circuit 302. Power may be selectively applied to the light sources 128,152 of the first and second illumination structures 120,144 according to at least one orientation sensor 306, which may also be in communication with the electric circuit 302. In one approach, the orientation sensor 306 may be a gravity-sensitive electric switch (a tilt switch).

In another approach, the orientation sensor 306 may be a proximity sensor configured to determine which illumination structure is facing the ground. For instance, in such approaches, there may be a first proximity sensor positioned near the first illumination structure 120 and a second proximity sensor positioned near the second illumination structure 144. Consider the case where the apparatus 100 comes to rest with the second illumination structure 144 facing the ground. In such a case, the second proximity sensor may perceive a proximity condition, i.e., determine that the second illumination structure 144 is closest to the ground. In contrast, the first proximity sensor would not perceive a proximity condition as the first illumination structure is facing upward (away from the ground). The electric circuit 302 may then use this information (either the perceived proximity condition from the second proximity sensor and/or the lack of a perceived proximity condition from the first proximity sensor) to power the light sources 128 of the first illumination structure 120 that are facing upward (away from the ground).

A receiver 308 (e.g. an antenna) in communication with the electric circuit 302 may also be located in the first and/or second internal compartments. The receiver 308 may be configured to receive a wireless signal, such as a radio frequency (RF) signal, that may instruct the apparatus to perform a desired action. The wireless signals may originate from a remote activation device, such as a key fob.

As also shown in FIG. 3, the electric circuit may be in communication with the optional status indicator light source 174, the optional reading light source 170, the power button 168, and the DIP switch 176 (and the particular selector switches included therein). In further approaches, the electric circuit may 302 be in communication with an optional camera unit, an optional audio device, and/or an optional gas dispensing unit in approaches where these additional components are coupled to the apparatus 100.

Referring now to FIG. 4, a simplified representation of a protective cover 400 configured to cover (and protect) at least a portion of a tactical light apparatus is shown according to one embodiment. The protective cover 400 may be used in conjunction with the apparatus 100 of FIGS. 1A-1B, as well as other apparatuses and/or features described in other embodiments and/or other FIGS. The protective cover 400 may also be used in various applications and/or in permutations which may or may not be specifically described in the illustrative embodiments listed herein. Moreover, unless otherwise specified, one or more components of the protective cover 400 may be of conventional material(s), design, fabricated using conventional techniques, and/or used in any desired environment as would become apparent to one skilled in the art upon reading the present disclosure.

The protective cover 400 may be particularly configured to mitigate and/or prevent damage to the tactical light apparatus (e.g., the apparatus 100 of FIGS. 1A-1B) on impact. In some approaches, the protective cover 400 may comprise a rigid, impact resistant layer. In other approaches, the protective cover 400 may comprise a resilient and/or deformable layer. In more approaches, the protective cover 400 may comprise rigid and deformable materials. In particular approaches, the protective cover 400 may comprise rubber, plastic, silicone, or other suitable material configured to provide impact resistance.

The protective cover 400 is preferably removable. However, in some approaches, the protective cover 400 may be permanently affixed to at least a portion of the apparatus 100.

As shown in the embodiment of FIG. 4, the protective cover 400 may be configured to cover the back and ancillary sides of a tactical light apparatus (e.g., the apparatus 100 of FIGS. 1A-1B), as well as at least the peripheral edges of the front and principle sides of said apparatus. As also shown in FIG. 4, the protective cover 400 has cutouts 402 configured to expose one or more portions of the principle sides and the front side of the tactical light apparatus.

While not shown in the embodiment of FIG. 4, the protective cover 400 may also be configured to cover one or more portions of the illuminations structures present on the principle sides of the tactical light apparatus, provided there are cutouts to expose the light sources thereof or the any material covering said light sources is transparent to the light produced from said light sources. Likewise, the protective cover 400 may additionally be configured to cover one Or more portions of the stabilization pads, and/or any other additional components, present on the principle sides of the tactical light apparatus provided that the presence of the cover does not interfere with the desired function of the stabilization pads and/or additional components.

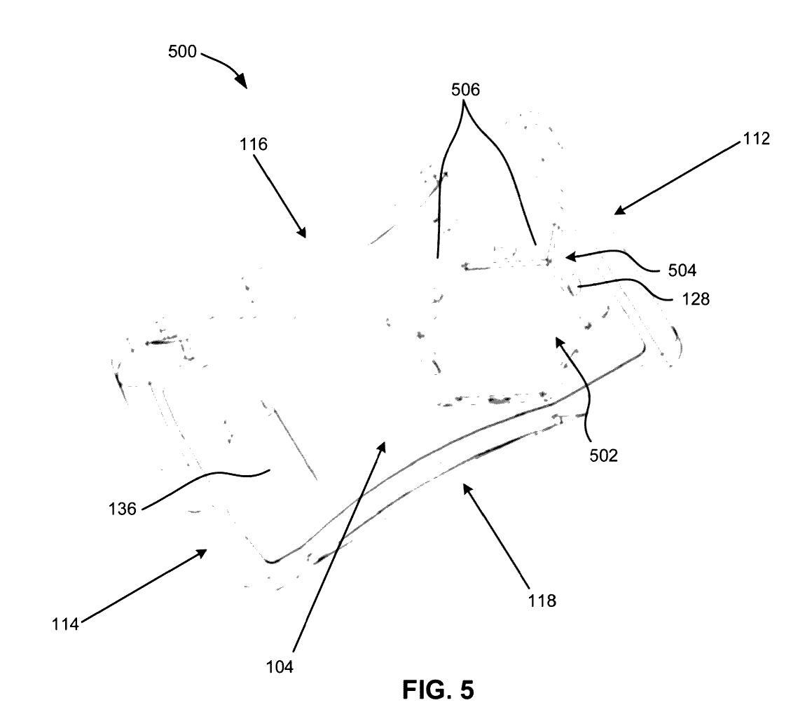

Referring now to FIG. 5, a tactical light apparatuses 500 is shown according to another embodiment. The apparatus 500 may include and/or be used in conjunction with features from any other embodiment listed, herein, such as those described, with reference to the other FIGS. However, the apparatus 500, and others presented herein. may be used in various applications and/or in permutations which may or may not be specifically described in the illustrative embodiments listed herein. Moreover, unless otherwise specified, one or more components of the apparatus 500 may be of conventional material(s), design, fabricated using conventional techniques, and/or used in any desired environment as would become apparent to one skilled in the art upon reading the present disclosure.

As the tactical light apparatus 500 is a variation of the apparatus 100 of FIGS. 1A-1B, the tactical light apparatus 500 may have common numbering with the apparatus 100 embodied bodied in FIGS. 1A-1B. Additionally, the tactical light apparatus 500 of FIG. 5 may have one or more of the same features, and/or one or more of the same dimensions as the tactical light apparatus 100 of FIGS. 1A-1B.

With reference to FIG. 5, the tactical light apparatus 500 includes a first illumination structure 502 protruding from its first principle side 104. The first illumination structure 502 has a hexagonal cross sectional shape with a faceted side surface 504. The faceted side surface 504 comprises six facets 506, to which are coupled light sources 128.

As also shown in FIG. 5, the first principle side 104 of the tactical light apparatus 500 also includes a first stabilization pad 136 protruding therefrom.

As further shown in FIG. 5, the tactical, light apparatus 500 includes: a front side 112 (which may have thereon an optional status indicator light source, an optional reading light source, a charging, connector, a power button, and/or a DIP switch); a back side 114; and ancillary sides 116,118.

While not shown in the view provided in FIG. 5, the tactical light apparatus 500 includes a second principle side that may have the same dimensions and/or features to hexagonally shaped illumination structure, light sources, a stabilization pad, etc.) to the first principle side 104. In addition, while also not shown in FIG. 5, the tactical light apparatus 500 may include various internal components (electric circuit, antenna, power source, orientation sensor, etc.) and external components (cameral, gas dispensing device, an audio device, a protective cover, etc.) disclosed in any other embodiment and/or any other FIG. herein.

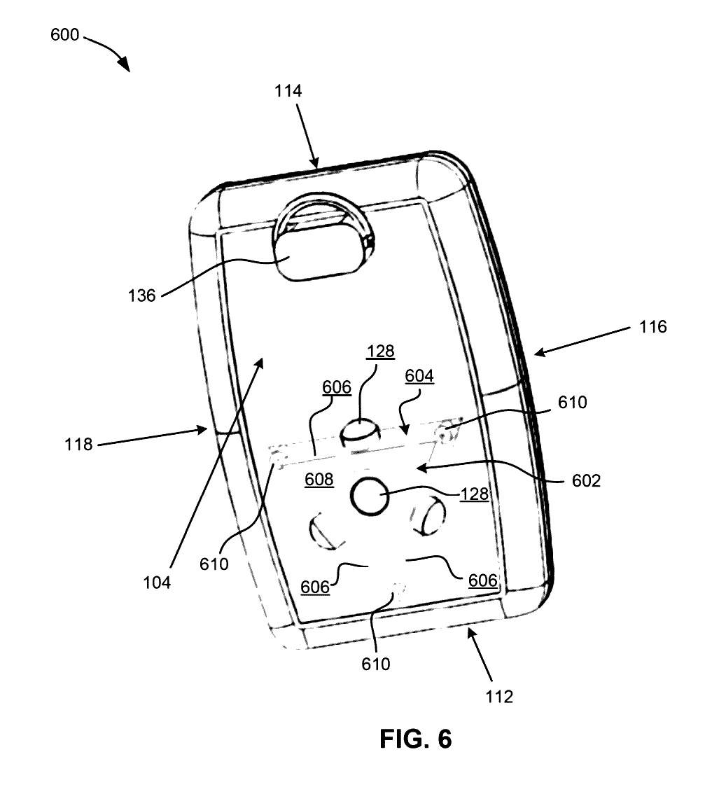

Referring now to FIG. 6, a tactical light apparatuses 600 is shown according to yet another embodiment. The apparatus 600 may include and/or be used in conjunction with features from any other embodiment listed herein, such as those described with reference to the other FIGS. However, the apparatus 600, and others presented herein, may be used in various applications and/or in permutations which may or may not be specifically described in the illustrative embodiments listed herein. Moreover, unless otherwise specified, one or more components of the apparatus 600 may be of conventional material(s), design, fabricated using conventional techniques, and/or used in any desired environment as would become apparent to one skilled in the art upon reading the present disclosure.

As the tactical light apparatus 600 is a variation of the apparatus 100 of FIGS. 1A-1B, the tactical light apparatus 600 may have common numbering with the apparatus 100 embodied in FIGS. 1A-1B. Additionally, the tactical light apparatus 600 of FIG. 6 may have one or more of the same features, and/or one or more of the same dimensions as the tactical light apparatus 100 of FIGS. 1A-1B.

With reference to FIG. 6, the tactical light apparatus 600 includes a first illumination structure 602 protruding from its first principle side 104. The first illumination structure 602 has a triangular cross sectional shape with a faceted side surface 604. The faceted side surface 604 comprises three facets 606, to which are coupled light sources 128. An additional light source 128 may also be optionally coupled to the exterior surface 608 of the first illumination structure 502. An optional “bumper” feature 610 may also be present at one or more of the junctions between facets 606.

As also shown in FIG. 6, the first principle side 104 of the tactical light apparatus 600 may include a first stabilization pad 136 protruding therefrom.

As further shown in FIG. 6, the tactical light apparatus 600 includes: a front side 112 (which may have thereon an optional status indicator light source, an optional reading light source, a charging connector, a power button, and or a DIP switch); a back side 114; and ancillary sides 116,118.

While not shown in the view provided in FIG. 6, the tactical light apparatus 600 includes a second principle side that has the same dimensions and/or features (a triangular shaped illumination structure, light sources, a stabilization pad, etc.) to the first principle side 104. In addition, while also not shown in FIG. 6, the tactical light apparatus 600 may include various internal components (electric circuit, antenna, power source, orientation sensor, etc.) external components (cameral, gas dispensing device, an audio device, a protective cover, etc.) disclosed in any other embodiment and/or any other FIG. herein.

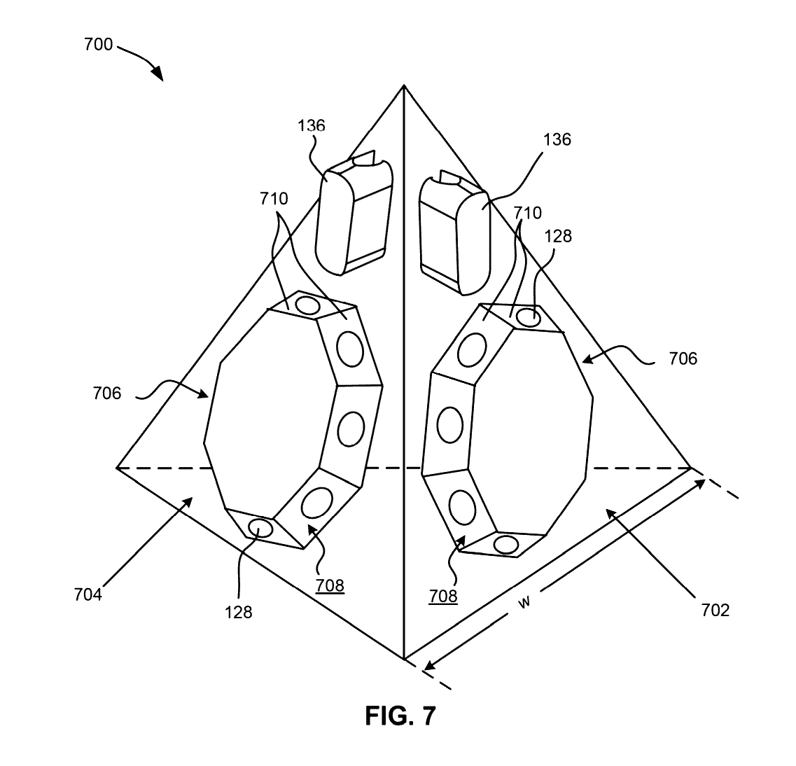

Referring now to FIG. 7, a tactical light apparatuses 700 having a tetrahedron shape is shown according to another embodiment. The apparatus 700 may include and/or be used in conjunction with features from any other embodiment listed herein, such as those described with reference to the other FIGS. However, the apparatus 700, and others presented herein, may be used in various applications and/or in permutations which may or may not be specifically described in the illustrative embodiments listed herein. Moreover, unless otherwise specified, one or more components of the apparatus 800 may be of conventional material(s), design, fabricated using conventional techniques, and/or used. in any desired environment as would become apparent to one skilled, in the art upon reading the present disclosure.

As the tactical light apparatus 700 is a variation of the apparatus 100 of FIGS. 1A-1B, the tactical light apparatus 700 may have common numbering with the apparatus 100 embodied in FIGS. 1A-1B. Additionally, the tactical light apparatus 700 of FIG. 7 may have one or more of the same features, and/or one or more of the same dimensions as the tactical light apparatus 100 of FIGS. 1A-1B.

With reference to FIG. 7, the tetrahedron shaped tactical light apparatus 700 includes four triangular principle sides. For instance the tetrahedron shaped tactical light apparatus 700 includes a first principle side 702, a second principle side 704, a third principle side (not shown), and a fourth principle side (not shown).

The tactical light apparatus 700 also includes at least one illumination structure 706 protruding from each of its four triangular principle sides. In some approaches, at least one of these triangular principle sides may have a width, w, in a range from about 3 inches to about 10 inches. In more approaches, the height of the tetrahedron shaped tactical light apparatus 700 may be in a range from about 3 inches to about 10 inches.

As particularly shown in FIG. 7, these illumination structures 706 have an octagonal cross sectional shape with a faceted side surface 708. The faceted side surface 708 comprises eight facets 710, to which are coupled light sources 128. It is important to note, however, that the cross sectional shape of one or more of the illumination structures 706 are not limited to an octagon, but may have other cross sectional shapes such as a circle, an ellipse, an oval, a triangle, a square, a rectangle, a pentagon, a hexagon, a heptagon, a rhombus, etc. Moreover, it is also important to note that the side surface of One or more of the illumination structure 706 need not be faceted but may instead be a continuous surface to which at least one light source 128 is coupled in some approaches. In preferred approaches, at least two, at least three, or all of illuminations structures 706 protruding from the four triangular principle sides may have the same dimensions, the same cross-sectional shape, the same type of side surface, and/or the same type of light sources 128, etc. as one another, but this need not be the case. In more preferred approaches, one or more of the illumination structures 706 of the tactical light apparatus 700 may be substantially similar or identical to any of the illumination structures described in FIGS. 1A-1B.

As also shown in FIG. 7, the tactical light apparatus 700 includes at least one stabilization pad 136 protruding from each of its four triangular principles sides.

While not shown in FIG. 7, the tactical light apparatus 700 may include various internal components (electric circuit, antenna, power source, orientation sensor, etc.) and external components (cameral, gas dispensing device, an audio device, a protective cover, etc.) disclosed in any other embodiment and/or any other FIG. herein. Moreover, while also not shown in FIG. 7, an optional status indicator light source, an optional reading light source, a charging connector, a power button, and/or a DIP switch may be positioned on one of the four triangular principle sides.

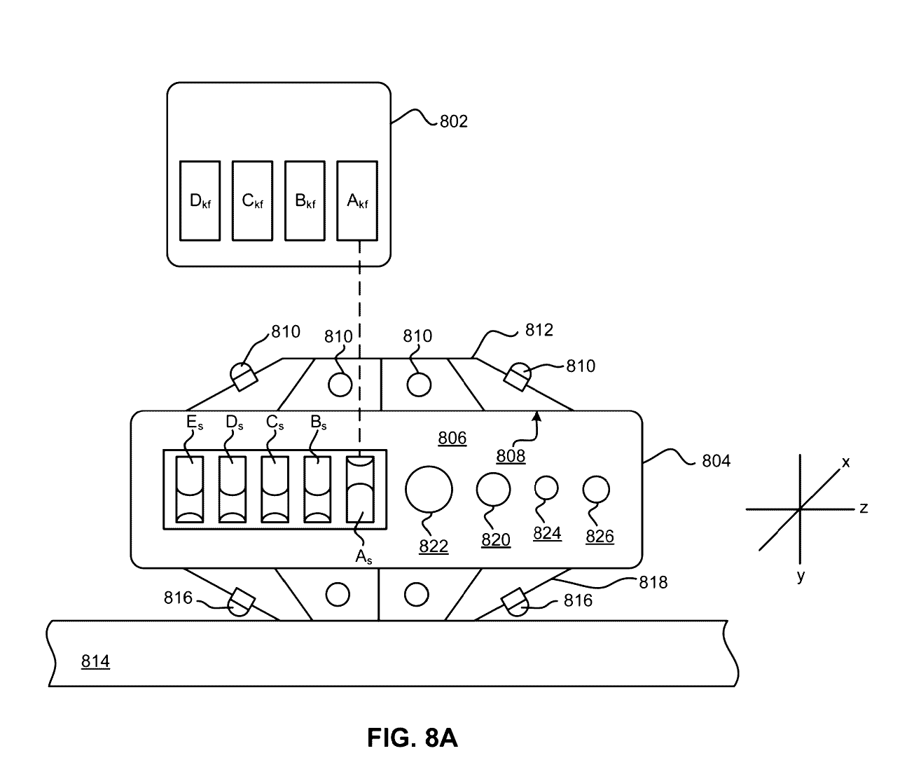

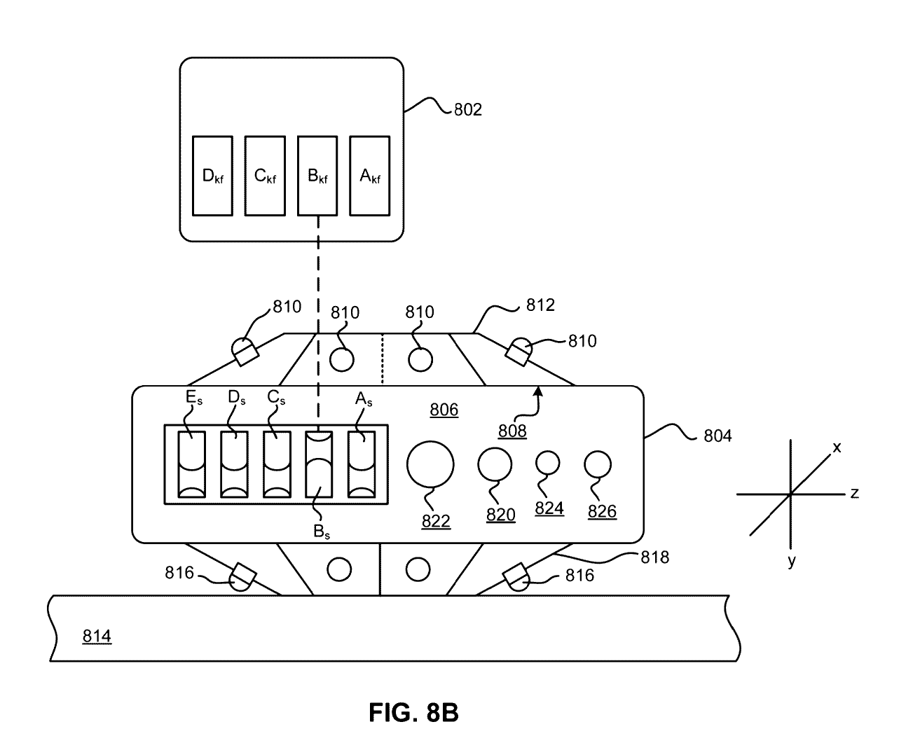

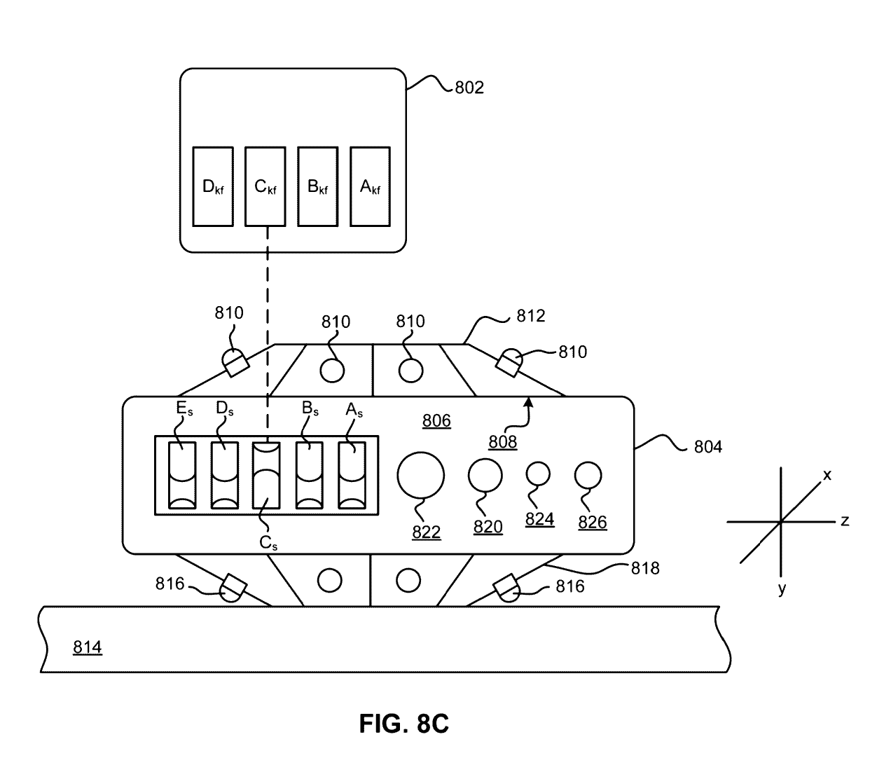

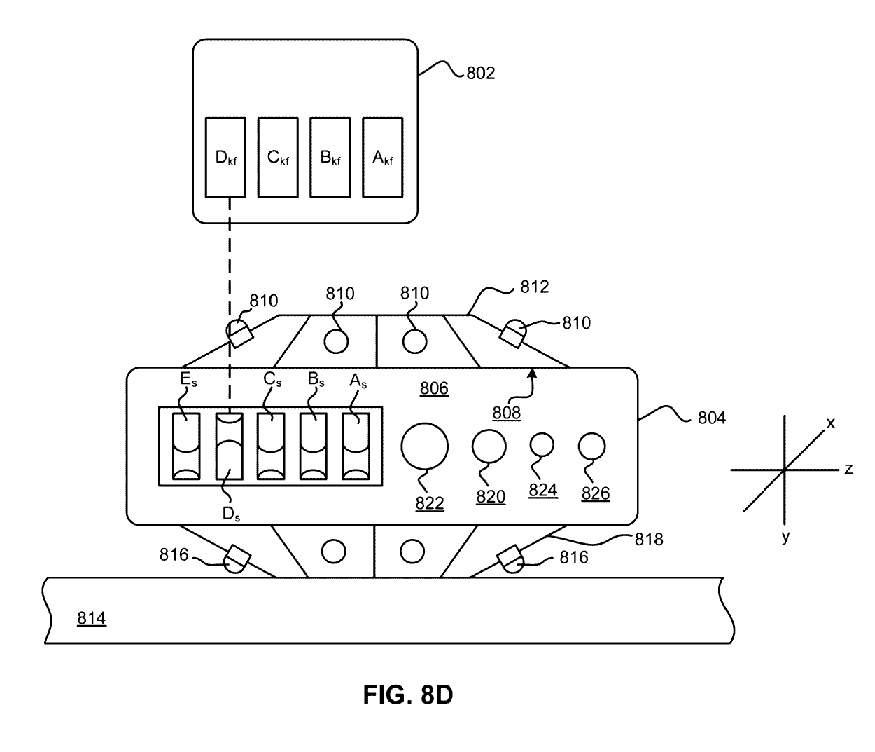

Referring now to FIGS. 8A-8D, an example of the communication between a key fob 802 and a tactical light apparatus 804 is shown according to one embodiment. In particular, FIGS. 8A-8D provides a front side view of the key fob 802 and/or the tactical light apparatus 804. The key fob 802 and/or the tactical light apparatus 804 may include and/or be used in conjunction with features from any other embodiment listed herein, such as those described with reference to the other FIGS. However, the key fob 802 and/or the tactical light apparatus 804 may be used in various applications and/or in permutations which may or may not be specifically described in the illustrative embodiments listed herein. Moreover, unless otherwise specified, one or more components of the key fob 802 and/or the tactical light apparatus 804 may be of conventional material(s), design, fabricated using conventional techniques, and/or used in any desired environment as would become apparent to one skilled in the art upon reading the present disclosure. Furthermore, the tactical light apparatus 804 may be substantially similar or identical to the apparatus 100 of FIGS. 1A-1B.

As shown in FIG. 8A, the key fob 802 is configured to communicate with the tactical light apparatus 804. Accordingly, the key fob 802 may include a transmitting device not shown, such as an antenna, that is configured to transmit signals (e.g., radio frequency signals) to the tactical light apparatus 804, While also not shown in FIG. 8A, the key fob 802 may also include one or more processors configured to control operation of the key fob 802, e.g., causing the key fob to transmit specific signals to the tactical light apparatus 804. The key fob 802 may additionally comprise a power source (not shown), such as a standard battery cell or other type of power source as known in the art. In preferred approaches, the key fob 802 may be a 433 MHz key fob.

As additionally shown in FIG. 8A, the key fob 802 includes four buttons labeled A_{kf}, B_{kf}, C_{kf}, and D_{kf}. Each button may be configured in such a way that when pressed by a user, a signal instruction associated with that particular button may be transmitted by the key fob 802 to the tactical light apparatus 804 so as to effectuate a desired action by said apparatus 804. In various approaches, the desired action by the tactical light apparatus 804 may include turning on one or more light sources associated therewith, and/or turning on one or more light sources associated therewith with a preset/predetermined brightness.

As further shown in FIG. 8A, the tactical light apparatus 804 has five selector switches, labeled Aₛ, Bₛ, Cₛ, Dₛ, and Eₛ, on the exterior surface 806 of its front side. The Aₛ switch is controlled by the A_{kf} button of the key fob 802; the Bₛ switch is controlled by the B_{kf} button of the key fob 802; the Cₛ switch is controlled by the C_{kf} button of the key fob 802; and the Dₛ switch is controlled by the Dr button of the key fob 802. For the purposes of this discussion, a switch may be activated (e.g., in the “on” position) when its lever is in the upper most position (i.e., closest to top edge 808 of the exterior surface 806). In preferred approaches, only one of the switches is activated (e.g., set to “on”) at a time.

In the particular embodiment shown in FIG. 8A, the tactical light apparatus 804 has only its Aₛ switch activated (e.g., in the “on” position). Accordingly, when the A_{kf} button of the key fob 802 is pushed by a user, the tactical light apparatus 804 is illuminated, e.g., the light source(s) 810 coupled to the illumination structure 812 that is(are) facing, upward (away from the floor 814) emit visible light (are turned on). If the user subsequently pushes the A_{kf} button of the key fob 802, the light sources 810 are turned off. Pushing any other button on the key fob 802 (e.g., buttons B_{kf}, C_{kf}, and D_{kf}) will not cause the light, sources 810 to turn on or off when only the Aₛ switch is activated.

While not shown in FIG. 8A, it is nonetheless important to note that if the tactical light apparatus 804 were to have a post-landing orientation in which the light sources 816 coupled to the illumination structure 818 were facing upwards, it would be these light sources 816 that would turn on (or off) with the push of the A_{kf} button.

In the particular embodiment shown in FIG. 8B, the tactical light apparatus 804 has only its Bₛ switch activated. Accordingly, when a user pushes the B_{kf} button of the key fob 802, the tactical light apparatus 804 is illuminated, e.g., the light sources 810 of the upward facing illumination structure 812 are turned on. If the user subsequently pushes the B_{kf} button of the key fob 802, the light sources 810 are turned off. Pushing any other button on the key fob 802 (e.g., buttons A_{kf}, C_{kf}, and D_{kf}) will not cause the light sources 810 to turn on or off when only the Bₛ switch is activated.

In the particular embodiment shown in FIG. 8C, the tactical light apparatus 804 has only its Cₛ switch activated. Accordingly, when a user pushes the C_{kf} button of the key fob 802, the tactical light apparatus 804 is illuminated, e.g., the light sources 810 of the upward facing illumination structure 812 are turned on. If the user subsequently pushes the C_{kf} button of the key fob 802, the light sources 810 are turned off. Pushing any other button on the key fob 802 (e.g., buttons A_{kf}, B_{kf}, and D_{kf}) will not cause the light sources 810 to turn on or oft when only the Cₛ switch is activated.

In the particular embodiment shown in FIG. 8D, the tactical light apparatus 804 has only its Dₛ switch activated. Accordingly, when a user pushes the D_{kf} button of the key fob 802, the tactical light apparatus 804 is illuminated, e.g., the light sources 810 of the upward facing illumination structure 812 are turned on. If the user subsequently pushes the D_{kf} button of the key fob 802, the light sources 810 are turned off. Pushing any other button on the key fob 802 (e.g., buttons A_{kf}, B_{kf}, and C_{kf}) will not cause the light sources 810 to turn on or off when only the Dₛ switch is activated.

Regarding the tactical light apparatus 804 described in FIGS. 8A-8D, which of its switches (e.g., Aₛ, Bₛ, Cₛ, or Dₛ) is activated may not only determine which corresponding button on the key fob 802 can illuminate the tactical light source 804 when pressed, but may also determine the degree to which the tactical light source 804 becomes illuminated (e.g., the brightness output of the light sources associated therewith), in various approaches. In particular, each of the switches Aₛ, Bₛ, Cₛ, and Dₛ may be associated with a unique, predetermined brightness output. For example, when the Aₛ switch on the tactical light apparatus 804 is activated and the A_{kf} button on the key fob 802 is pressed, the light sources 810 of the upward facing illumination structure 812 may emit visible light with a highest brightness output (e.g., a brightness output ranging from about 100% to > about 75%). However, when the when the Bₛ switch on the tactical light apparatus 804 is activated and the Bid button on the key fob 802 is pressed, the light sources 810 of the upward facing illumination structure 812 may emit visible light with a lower brightness output (e.g., a brightness output ranging from about 75% to > about 50%). Likewise, when the when the Cₛ switch on the tactical light apparatus 804 is activated and the C_{kf} button on the key fob 802 is pressed, the light sources 810 of the upward facing illumination structure 812 may emit visible light with an even lower brightness output (e.g.,. a brightness output ranging from about 50% to > about 25%). Finally, when the when the Dₛ switch on the tactical light apparatus 804 is activated and the D_{kf} button on the key fob 802 is pressed, the light sources 810 of the upward facing illumination structure 812 may emit visible light with an the lowest brightness output (e.g., a brightness output ranging from about 25% to ≧ about 0%).

Additionally, in various approaches, which of the tactical light apparatus 804 switches (e.g., Aₛ, Bₛ, Cₛ, or Dₛ) is activated may not only determine which corresponding button on the key fob 802 can illuminate the tactical light source 804 when pressed, but may also determine which particular light sources of the tactical light source 804 become illuminated. For instance, in some approaches, one or more of light sources on an illumination structure may be configured to emit a different wavelength than the other light sources on said illumination structure. By way of example only, consider the case where: a first set of light sources on each illumination structure are configured to emit a yellow color and are associated with the Aₛ switch; whereas a second set of light sources on each illumination structure are configured to emit a white color and are associated with the Bₛ switch. When the Aₛ switch on the tactical light apparatus 804 is activated and the A_{kf} button on the key fob 802 is pressed, only the first set of light sources 810 of the upward facing illumination structure 812 may turn on and produce yellow light. However, when the Bₛ switch on the tactical light apparatus 804 is activated, and the B_{kf} button on the key fob 802 is pressed, only the second set of light sources 810 of the upward facing illumination structure 812 may turn on and produce white light. The other switches (Cₛ and/or Dₛ) of the tactical light apparatus 804 may be associated with light sources that may be configured to produce colors other than yellow or white, and/or be associated with the brightness output of the aforementioned first and/or second set of light sources. For example, when the Cₛ switch on the tactical light apparatus 804 is activated and the C_{kf} button on the key fob 802 is pressed, a third set of light sources 810 of the upward facing illumination structure 812 may turn on and produce a red color. Alternatively, when the Cₛ switch on the tactical light apparatus 804 is activated and the C_{kf} button on the key fob 802 is pressed, the first (or second) set of light sources 810 of the upward facing illumination structure 812 may turn on and produce its respective color albeit with a lower brightness output (as compared to when the Aₛ switch is activated).

Moreover, another non-limiting example, consider the case where: a first set of light sources on each illumination structure are strobe lights (i.e., are configured to flash) and are associated with the Aₛ switch; whereas a second set of light sources 810 on each illumination structure are not strobe lights (i.e. are not configured to flash) and are associated with the Bₛ switch. When the Aₛ switch on the tactical light apparatus 804 is activated and the A_{kf} button on the key fob 802 is pressed, only the first set of probe light sources of the upward facing illumination structure 812 may turn on and produce flashing light. However, when the Bₛ switch on the tactical light apparatus 804 is activated and the B_{kf} button on the key fob 802 is pressed, only the second set of non-probe light sources of the upward facing illumination structure 812 may turn on and produce a steady/constant light output. The other switches (Cₛ and/or Dₛ) of the tactical light apparatus 804 may be associated with light sources of a different type than the first and second set of light sources, and/or be associated with the brightness output of the aforementioned first and/or second set of light sources, and/or be associated with light sources that produce light of a different color than the first and/or second sets of light sources, etc.

It is important to note that there may be various combinations of light sources that may differ with respect to one another based on type, wavelength emitted, brightness, etc. For instance, in yet another non-limiting example consider the case where: a first set of light sources on each illumination structure are configured to emit a white light and are associated with the Aₛ switch; a second set of light sources on each illumination structure are configured to emit a yellow light and are associated with the Bₛ switch; and a third set of light sources on each illumination structure are probe lights and are associated with the Cₛ switch. When the Aₛ switch on the tactical light apparatus 804 is activated and the A_{kf} button on the key fob 802 is pressed, only the first set of light sources 810 of the upward facing illumination structure 812 may turn on and produce white light. However, when the Bₛ switch on the tactical light apparatus 804 is activated and the B_{kf} button on the key fob 802 is pressed, only the second set of light sources 810 of the upward facing illumination structure 812 may turn on and produce yellow light. Moreover, when the Cₛ switch on the tactical light apparatus 804 is activated and the C_{kf} button on the key fob 802 is pressed, only the third set of probe light sources 810 of the upward facing illumination structure 812 may turn on and produce flashing light. Finally, the Dₛ switch of the tactical light apparatus 804 may be associated with the brightness output of the first, second or third set of light sources, such that when the Dₛ switch is activated and the D_{kf} button on the key fob 802 is pressed, the first, second, or third set of light sources may turn on albeit with a lower brightness output.

With continued reference to FIGS. 8A-8D, the tactical light apparatus 804 may also have an optional reading light source 820 coupled to its exterior surface. In various approaches, the Eₛ switch of the tactical light apparatus 804 may be associated with the operation of the reading light source 820. For example, in some approaches, arriving the Eₛ switch (i.e., sliding the lever of the Eₛ switch to the “on” position) may immediately cause the reading light source 820 to emit visible light. However, in other approaches, the Eₛ switch may be controlled by a fifth button (not shown) on the key fob 802, such that when the Eₛ switch is activated (in the “on” position) and a user pushes the fifth button, the reading light source 820 is turned on.

As discussed previously and as also shown in FIGS. 8A-8D, the front side of the apparatus 804 may additionally include one or more of: a charging connector 822, a power button 826, and a status indicator light source 824.

The tactical light apparatus 804 described in FIGS. 8A-8D is not limited to communication with only a single key fob 802. For instance as noted previously, the key fob 802 may be any conventional four (or five) button key fob as known in the art. Accordingly, two or more such conventional four or five) button key fobs 802 may be used to communicate (and illuminate) the tactical light apparatus 804.

Additionally, the key fob 802 described in FIGS. 8A-8D may also not be limited to communication with a single tactical light apparatus 804. For example, there may be a plurality of the tactical light apparatuses 804, with some having their Aₛ switch activated, some having their Bₛ switch activated, some having, their Cₛ switch activated, and/or some having their Dₛ switch activated. The key fob 802 may be configured to communicate with each of these tactical light apparatuses 804, e.g., pressing the A_{kf} button of the key fob 802 may illuminate those tactical light apparatuses 804 having their Aₛ switch activated, pressing the B_{kf} button of the key fob 802 may illuminate those tactical light apparatuses 804 having their Bₛ switch activated, etc.

The communication configuration between the tactical light apparatus 804 and the key fob 802, as described in FIGS. 8A-8D, may be advantageous in situations where there are a plurality of the tactical light apparatuses 804 and a plurality the key fobs 802. For instance, consider an exemplary case where a plurality of law enforcement officers are responding to a threatening situation at a residence having at least one un-illuminated (non-lit) area/room. As time is of the essence, each officer may select one key fob from amongst a group of said key fobs, as well as one tactical light apparatus from amongst a group of said tactical light apparatus. Each officer does not need to worry about pairing their selected tactical light apparatus with a specific key fob, as each tactical light apparatus is able to be illuminated by virtue of pressing one of the buttons on the key fob (provided the corresponding switch o the tactical light apparatus is in the “on” position).

While perhaps not as advantageous, the tactical light apparatus 804 of FIGS. 8A-8D may be limited to communication with a single key fob 802 in alternative approaches. Such a configuration is similar to a remote garage door opener that is configured to communicate with only a particular garage door, or an automobile keyless entry device configured to only open or otherwise control. In approaches where the tactical light apparatus 804 of FIGS. 8A-8D may be limited to communication with a single key fob 802, the tactical light apparatus 804 and the tactical light apparatus may be colored coded in such a way (e.g., they may each have the same color casing/housing) to enable a user to easily identify these paired devices.

Additionally, while the key fob 802 includes four buttons and the tactical light apparatus 804 includes five selector switches, as shown in FIGS. 8A-8D, this need not be the case. In alternative approaches, the key fob may only have one button, two buttons, three buttons, four buttons, five buttons, etc. Similarly, the number of selector switches on the tactical light apparatus may be one, two, three, four, five, six, etc. For instance, in one approach, the tactical light apparatus may have one selector switch controlled by the only button of a single button key fob (or a particular button of a multi-button key fob), such that when the selector switch is activated and key fob button is pushed, the tactical light apparatus is illuminated. In another approach, the tactical light apparatus may have two selector switch controlled by two buttons of a dual-button key fob or two buttons of a multi-button key fob), such that when one of the selector switches is activated and the corresponding key fob button is pushed, the tactical light apparatus is illuminated, and when the other of the selector switches is activated and the corresponding key fob button is pushed, the tactical light apparatus is illuminated but with a lower brightness output. Additional configurations are also possible.

The inventive concepts disclosed herein have been presented by way of example to illustrate the features thereof in a plurality of illustrative scenarios, embodiments, and/or implementations. It should be appreciated that the concepts generally disclosed are to be considered modular, and may be implemented in any combination, permutation, or synthesis thereof. Additionally, any modification, alteration, or equivalent of the features, functions, and concepts disclosed herein that would become apparent to a person having ordinary skill in the art upon reading the present disclosure should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An apparatus comprising:
a housing including at least two principle sides;
an illumination structure protruding from each of the two principle sides;
a stabilization pad protruding from each of the two principle sides;
an electric circuit coupled to the housing;
an antenna coupled to the housing;
at least one orientation sensor coupled to the housing; and
an electric power source coupled to the housing.

2. The apparatus as recited in claim 1, wherein the antenna is configured to receive at least one radio frequency signal from a remote activation device.

3. The apparatus as recited in claim 1, wherein the apparatus has a generally rectangular shape, and wherein the at least two principle sides are parallel to one another.

4. The apparatus as recited in claim 1, wherein a cross sectional shape of at least one of the illumination structures is selected from a group consisting of: an octagon, a heptagon, a hexagon, a pentagon, a rectangle, a square, a triangle, a circle, and an ellipse.

5. The apparatus as recited in claim 1, wherein the illumination structures each comprise one or more light sources coupled thereto.

6. The apparatus as recited in claim 5, wherein the light sources are light emitting diodes.

7. The apparatus as recited in claim 5, wherein the one or more light sources are controlled by a remote activation device.

8. The apparatus as recited in claim 5, wherein the one or light sources of each illumination structure are selectively powered based on an orientation of the apparatus at rest.

9. The apparatus as recited in claim 5, at least one of the illumination structures has a faceted side surface, and wherein at least one light source is coupled to each facet thereof.

10. The apparatus as recited in claim 1, wherein the housing further comprises a front side and a back side, wherein the front side and the back side are each oriented perpendicular to the at least two principle sides.

11. The apparatus as recited in claim 10, further comprising a reading light source protruding from the front side of the housing.

12. The apparatus as recited in claim 10, further comprising a status indicator light source protruding from the front side of the housing.

13. The apparatus as recited in claim 10, further comprising a charging connector on the front side of the housing, and wherein the power source includes at least one rechargeable battery.

14. The apparatus as recited in claim 10, further comprising at least five selector switches on the front side of the housing.

15. The apparatus as recited in claim 14, wherein one or more light sources coupled to each illumination structure are controlled by a unique signal transmitted from a remote activation device when one of the five selector switches is set to an on position.

16. The apparatus as recited in claim 1, further comprising a protective cover coupled to at least one portion of the housing.

17. The apparatus as recited in claim 16, wherein the protective cover comprises rubber.

18. The apparatus as recited in claim 1, further comprising an audio device, a camera, and/or a gas dispensing device coupled to at least one of the principle sides of the housing.

19. The apparatus as recited in claim 1, wherein a height of the stabilization pad is about equal to a height of the illumination structure.

20. The apparatus as recited in claim 1, wherein a length of the housing is about 4.6 inches, and wherein a width of the housing is about 3 inches.
